(19) United States
(12) Patent Application Publication
(10) Pub. No.: US 2026/0346092 A1
(43) Pub. Date: Nov. 5, 2026

(54) ELECTRONIC DEVICE AND ELECTRONIC DEVICE OPERATION METHOD

(71) Applicant: Samsung Electronics Co., Ltd., Suwon-si (KR)

(72) Inventors: Juyeon YOU, Suwon-si (KR); Seungjoon LEE, Suwon-si (KR); Jaemo CHOI, Suwon-si (KR); Jinyoung CHOI, Suwon-si (KR); Dhojin HAN, Suwon-si (KR)

(21) Appl. No.: 19/706,586

(22) Filed: Jun. 12, 2026

Related U.S. Application Data
(63) Continuation of application No. PCT/KR2024/016908, filed on Oct. 31, 2024.

(30) Foreign Application Priority Data
Dec. 15, 2023 (KR) 10-2023-0183292

(51) Int. Cl. A63B 24/00; A63B 71/06

(52) U.S. Cl. CPC A63B 24/0075; A63B 24/0062; A63B 71/0619; A63B 2024/0065; A63B 2071/0647; A63B 2071/065

(57) ABSTRACT

An electronic device for exercise of a user is provided. The electronic device includes at least one sensor, a communication unit, memory, including one or more storage media, storing instructions, and at least one processor electrically connected to the memory, the at least one sensor and the communication unit, wherein the instructions, when executed by the at least one processor individually or collectively, cause the at least one processor to identify a user device located adjacent to the electronic device via at least one of the at least one sensor or the communication unit, receive first physical condition information about a user from the user device via the communication unit, generate recommended exercise information and information regarding a user capturing condition based on the first physical condition information about the user, transmit the recommended exercise information and the information regarding the imaging condition to an imaging device, receive captured data from the imaging device, and display an exercise guide screen based on the exercise information and the captured data.

### CROSS-REFERENCE TO RELATED APPLICATION(S)

This application is a continuation application, claiming priority under 35 U.S.C. § 365(c), of an International application No. PCT/KR2024/016908, filed on Oct. 31, 2024, which is based on and claims the benefit of a Korean patent application number 10-2023-0183292, filed on Dec. 15, 2023, in the Ministry of Intellectual Property Office (MOIP), the disclosure of which is incorporated by reference herein in its entirety.

### BACKGROUND

### 1. Field

The disclosure relates to an electronic device and a method for operating the electronic device.

### 2. Description of Related Art

As home training becomes popularized, various home training devices are being developed. Among the devices for home training, smart devices that may operate connected to an Internet of Things (IoT) server may collect and analyze the user's exercise data and provide a personalized training experience. For example, by using a wearable device (e.g., a smart watch, a smart band, etc.) including a sensor capable of measuring the user's physical condition, data such as heart rate, the number of steps, and calories burned may be measured, and aerobic exercise devices such as a smart treadmill may display exercise data to the user in real-time through a screen and may transmit and store training history to the server, and through the server, the user may receive a personalized exercise service.

The above information is presented as background information only to assist with an understanding of the disclosure. No determination has been made, and no assertion is made, as to whether any of the above might be applicable as prior art with regard to the disclosure.

### SUMMARY

In the case of home training, it may be difficult for the user to be correctly provided with information about the exercise type and posture required for the user.

Aspects of the disclosure are to address at least the above-mentioned problems and/or disadvantages and to provide at least the advantages described below. Accordingly, an aspect of the disclosure is to provide an apparatus and method for assisting the exercise of a user performing home training.

Additional aspects will be set forth in part in the description which follows and, in part, will be apparent from the description, or may be learned by practice of the presented embodiments.

In accordance with an aspect of the disclosure, an electronic device for the exercise of a user is provided. The electronic device includes at least one sensor, a communication unit, memory, including one or more storage media, storing instructions, and at least one processor electrically connected to the memory, the at least one sensor and the communication unit. In an embodiment, the instructions, when executed by the at least one processor individually or collectively, cause the at least one processor to identify a user device located adjacent to the electronic device via at least one of the at least one sensor or the communication unit, receive, via the communication unit, first physical condition information of the user from the user device, generate recommended exercise information and information regarding a user capturing condition based on the first physical condition information of the user, transmit the recommended exercise information and the information regarding the capturing condition to an imaging device, receives captured data from the imaging device, and display an exercise guide screen based on the exercise information and the captured data.

In an embodiment, the processor may receive, via the communication unit, information regarding exercise history from the user device. In an embodiment, the processor may generate the recommended exercise information based on the information regarding the exercise history and the first physical condition information.

In an embodiment, the electronic device, the at least one sensor may include a camera. In an embodiment, the processor may recognize at least a part of the user's body via the camera. In an embodiment, the processor may identify the user based on at least a part of the user's body.

In an embodiment, the processor may identify a direction in which the user is looking based on the captured data.

In an embodiment, the electronic device may include an image projection unit electrically connected to the processor. In an embodiment, the processor may project, via the image projection unit, toward the direction, an image including information regarding an exercise state of the user.

In an embodiment, the electronic device may include a motor connected to the processor. In an embodiment, the processor may identify the exercise state of the user based on an electrical signal identified by the motor. In an embodiment, the processor may generate exercise information based on the exercise state.

In an embodiment, the processor may update the exercise information based on at least one of the first physical condition information, second physical condition information obtained via the at least one sensor, or the captured data.

In an embodiment, the information regarding the capturing condition may include information regarding at least one position at which the imaging device is to capture the user, information regarding a capturing region, and information regarding a movement path.

In accordance with another aspect of the disclosure, a user device is provided. The user device includes at least one sensor, a communication unit, a display, memory, comprising one or more storage media, storing instructions, and at least one processor electrically connected to the at least one sensor, the communication unit, the memory, and the display, wherein the instructions, when executed by the at least one processor individually or collectively, cause the at least one processor to obtain first physical condition information of a user using the at least one sensor, transmit the first physical condition information to an exercise device, receive exercise information and captured data from the exercise device, and display the guide screen on the display based on the exercise information and the captured data.

In an embodiment, the processor may obtain the second physical condition information by using the at least one sensor. In an embodiment, the processor may transmit the second physical condition information to the exercise device.

In an embodiment, the processor may transmit identification information of the user to the exercise device via the communication unit.

In an embodiment, the processor may transmit the first physical condition information to the server device via the communication unit. In an embodiment, the processor may receive the exercise information and the captured data from the server device via the communication unit. In an embodiment, the server device may include an Internet of Things (IoT) server device managing the user device and the exercise device.

In accordance with another aspect of the disclosure, a method performed by an electronic device for exercise of a user is provided. The method includes identifying a user device located adjacent to the electronic device, receiving, via the communication unit, first physical condition information of the user from the user device, generating recommended exercise information and information about a user capturing condition based on the first physical condition information of the user, transmitting the recommended exercise information and the information about the capturing condition to an imaging device, receiving captured data from the imaging device, and displaying an exercise guide screen based on the exercise information and the captured data.

In an embodiment, the method for operating the electronic device may include an operation of receiving information regarding exercise history from the user device. In an embodiment, the method for operating the user device may include an operation of generating the recommended exercise information based on the information regarding the exercise history and the first physical condition information.

In an embodiment, the method for operating the electronic device may include an operation of recognizing at least a part of the user's body via a camera. In an embodiment, the method for operating the user device may include an operation of identifying the user based on at least a part of the user's body.

In an embodiment, the method for operating the electronic device may include an operation of identifying a direction in which the user is looking based on the captured data.

In an embodiment, the method for operating the electronic device may include an operation of projecting, via an image projection unit, toward the direction, an image including information regarding an exercise state of the user.

In an embodiment, the method for operating the electronic device may include an operation of identifying the exercise state of the user based on an electrical signal identified by a motor. In an embodiment, the method for operating the user device may include an operation of generating the exercise information based on the exercise state.

In an embodiment, the method for operating the electronic device may include an operation of updating the exercise information based on at least one of the first physical condition information, second physical condition information obtained via at least one sensor, or the captured data.

In an embodiment, the information regarding the capturing condition may include information regarding at least one position at which the imaging device is to capture the user, information regarding a capturing region, and information regarding a movement path.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying a user device located adjacent to the electronic device, receiving first physical condition information of a user from the user device via a communication unit, generating recommended exercise information and information about a user capturing condition based on the first physical condition information of the user, transmitting the recommended exercise information and the information about the capturing condition to an imaging device, receiving captured data from the imaging device, and displaying an exercise guide screen based on exercise information and the captured data.

The embodiments of the disclosure provide an effect of recommending an exercise type based on the physical condition of the user and providing an exercise type adaptively according to the condition of the user.

In addition, the embodiments of the disclosure provide an effect of being able to monitor an exercise posture of the user and provide feedback thereon.

In addition, the embodiments of the disclosure provide an effect of being able to accurately monitor an exercise posture of the user via various sensors of electronic devices included in an exercise environment.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates an example of an exercise environment of a user according to an embodiment of the disclosure;

FIG. 1B illustrates an example of an IoT environment of a user according to an embodiment of the disclosure;

FIG. 2 is a block diagram of an electronic device 201 in a network environment according to an embodiment of the disclosure;

FIG. 3 illustrates a block configuration of a display device according to an embodiment of the disclosure;

FIG. 4A illustrates an exercise device according to an embodiment of the disclosure;

FIG. 4B illustrates a block configuration of an exercise device according to an embodiment of the disclosure;

FIG. 5 illustrates a block configuration of an imaging device according to an embodiment of the disclosure;

FIG. 6 illustrates a signaling flow of a user device, an exercise device, an imaging device, and a display device according to an embodiment of the disclosure;

FIG. 7 illustrates an operation flow of an electronic device according to an embodiment of the disclosure;

FIG. 8 illustrates an operation flow of a user device according to an embodiment of the disclosure;

FIG. 9 illustrates an example of an operation of a sensor included in an electronic device according to an embodiment of the disclosure;

FIG. 10 illustrates an example of user capturing by an imaging device according to an embodiment of the disclosure;

FIG. 11 illustrates an example of obtaining captured data according to an embodiment of the disclosure;

FIG. 12 illustrates an example of obtaining captured data according to an embodiment of the disclosure;

FIG. 13 illustrates an example of obtaining captured data according to an embodiment of the disclosure;

FIG. 14 illustrates an example of an exercise environment of a user according to an embodiment of the disclosure;

FIG. 15 illustrates an example of a guide screen according to an embodiment of the disclosure;

FIG. 16 illustrates an exercise environment of a user according to an embodiment of the disclosure;

FIG. 17 illustrates an example of displaying a guide screen according to an embodiment of the disclosure;

FIG. 18 illustrates an example of displaying a guide screen according to an embodiment of the disclosure;

FIG. 19 illustrates an example of displaying a guide screen according to an embodiment of the disclosure;

FIG. 20 illustrates an example of displaying a guide screen according to an embodiment of the disclosure;

FIG. 21 illustrates an example of displaying feedback information according to an embodiment of the disclosure;

FIG. 22 illustrates an example of feedback information according to an embodiment of the disclosure;

FIG. 23 illustrates an example of displaying a guide screen according to an embodiment of the disclosure;

FIG. 24 illustrates an example of displaying a guide screen according to an embodiment of the disclosure;

FIG. 25 illustrates an example of displaying a guide screen according to an embodiment of the disclosure;

FIG. 26 illustrates an example of displaying a guide screen according to an embodiment of the disclosure; and

FIG. 27 illustrates an example of a guide screen according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

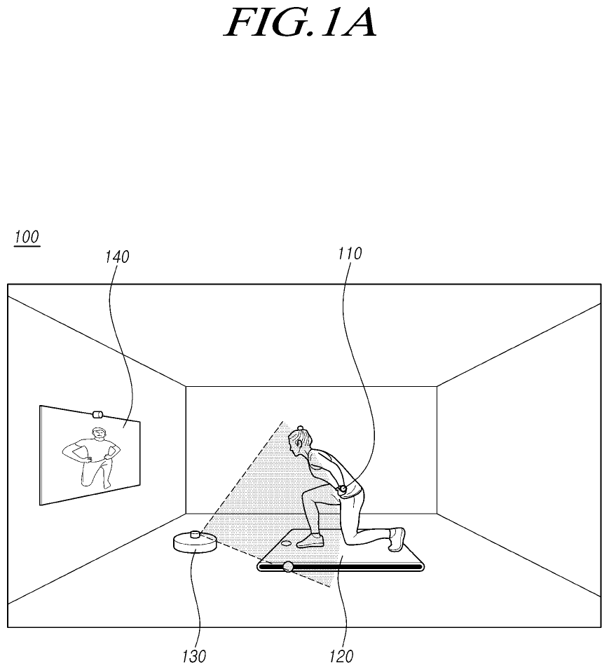

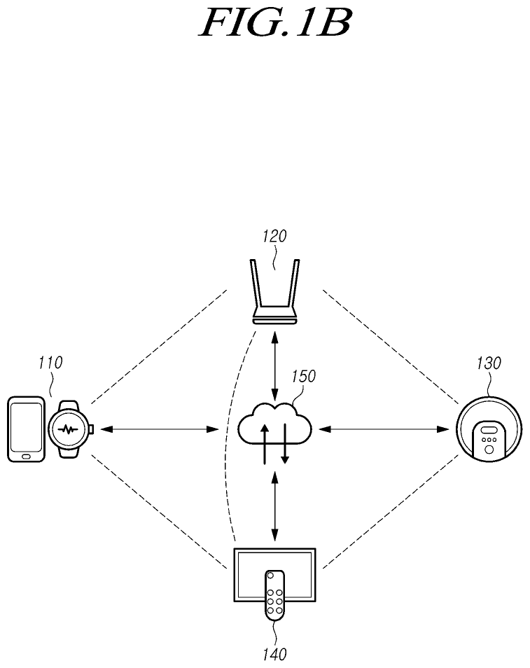

FIG. 1A illustrates an example of an exercise environment of a user according to an embodiment of the disclosure. FIG. 1B illustrates an example of an IoT environment of a user according to an embodiment of the disclosure.

Referring to FIGS. 1A and 1B, the exercise environment 100 of the user may include a device located in the vicinity of the user performing home training or a server device for communicating data with a device located in the vicinity. The exercise environment 100 of the user may include a user device 110, an exercise device 120, an imaging device 130, a display device 140, and a server device 150 of the user performing exercise.

In an embodiment, the user device 110 may be a device that the user may carry, and may include a sensor capable of sensing the physical condition of the user and a communication module capable of transmitting data relating to the sensed state to another device. For example, the user device 110 may include a smartphone, a smart watch, a smart band, a smart ring, etc.

In an embodiment, the exercise device 120 may include a device for enabling the user to perform an exercise. The exercise performed by the user may include strength exercise and aerobic exercise. The exercise device 120 may include a motor (not shown) and accessories (not shown) to enable the user to perform an exercise. The exercise device 120 may be referred to as a training device, a fitness device, a workout device, etc. The configuration of the exercise device 120 may be described in detail in the drawings described below.

In an embodiment, the imaging device 130 may be a device that captures a user performing an exercise on the exercise device 120, and may capture the exercise posture of the user at various positions and angles while moving around the user. The imaging device 130 may be implemented through a robot vacuum cleaner. The imaging device 130 may be referred to as a measurement device, a monitoring device, a training imaging device, an exercise analysis device, etc.

In an embodiment, the display device 140 may include a device for providing a guide screen to a user performing an exercise. For example, the display device may include a TV, a monitor, and a screen device. The display device 140 may also include a sensor (e.g., a camera) for capturing the exercise posture of the user.

Referring to FIG. 1A, a user wearing the user device 110 may perform an exercise on the exercise device 120. The imaging device 130 may capture a user performing an exercise while moving around the user. Photographed data and feedback information may be displayed on the display device 140.

Referring to FIG. 1B, the user device 110, the exercise device 120, the imaging device 130, the display device 140, and the server device 150 may communicate data with each other for the user's exercise.

According to an embodiment, the exercise device 120 and the imaging device 130 may communicate data with each other, capture a user performing an exercise, and may generate feedback information based on the captured data. The exercise device 120 may transmit to the imaging device 130 information relating to the exercise performed by the user (e.g., information relating to the type of exercise, weight, number of repetitions, frequently incorrect movements, and movements at risk of injury) and information relating to capturing conditions. The imaging device may capture the user performing an exercise based on information relating to the exercise performed by the user and information relating to capturing conditions received from the exercise device 120, and may obtain captured data. The imaging device 130 may transmit the captured data to the exercise device 120. The exercise device 120 may generate feedback information based on the received captured data.

According to an embodiment, when the user device 110 operates in a server mode, the user device 110, the exercise device 120, the imaging device 130, and the display device 140 may each perform data communication with the server device 150.

In an embodiment, the server device 150 may receive, from the user device 110, data relating to the physical condition of the user (e.g., information relating to heart rate, blood pressure, and body temperature) and identification information of the user.

In an embodiment, the server device 150 may transmit, to the user device 110, information relating to a user wearing the user device 110 and information relating to exercise history of the user.

In an embodiment, the server device 150 may receive, from the exercise device 120, body information and exercise data of the user. The body information may include body composition information of the user measured from a sensor included in the exercise device 120 and information relating to heart rate. The exercise data of the user may include information relating to the user's exercise measured from the exercise device 120 (e.g., exercise history, type of exercise, weight, number of repetitions (reps), and speed).

In an embodiment, the server device 150 may transmit, to the exercise device 120, information relating to exercise conditions of the user. The information relating to exercise conditions of the user may include information relating to recommended exercise, which the server device 150 determines based on body information of the user received from the user device 110. For example, the information relating to exercise conditions of the user may include information relating to the type of recommended exercise, weight, number of repetitions, and settings (e.g., length of cable, position of cable, position of handle, position of footboard, height of accessory, etc.).

In an embodiment, the server device 150 may receive, from the imaging device 130, captured data obtained by capturing, by at least one of the imaging device 130 and the display device 140, a user performing an exercise. For example, the captured data may include image or video data relating to the exercise posture of the user captured based on at least one position and at least one angle.

In an embodiment, the server device 150 may transmit, to the imaging device 130, information relating to capturing conditions and information relating to recommended exercise of the user. The capturing condition may be determined based on the type of recommended exercise, and may include information relating to a position where the imaging device 130 captures the user, information relating to a capturing angle, information relating to a capturing time, information relating to a reference posture, etc.

In an embodiment, the server device 150 may obtain, from the display device 140, an image of the user captured based on at least one sensor included in the display device 140. A user performing an exercise may be captured not only via the imaging device 130 but also via the display device 140.

In an embodiment, captured data may be obtained via at least one sensor (e.g., a camera) included in the display device 140. A user may be recognized via the sensor included in the display device, and captured data may be obtained by capturing a user performing an exercise via the sensor. For example, when the imaging device 130 is not present and the information relating to capturing conditions directs capturing of the user's front side, captured data may be obtained via the display device 140 instead of the imaging device 130.

In an embodiment, the server device 150 may generate information relating to a guide screen based on information received from the user device 110, the exercise device 120, and the imaging device 130. The information relating to the guide screen may include information relating to an exercise to be performed by the user, information relating to a currently captured posture of the user, and information relating to a current physical condition (e.g., heart rate, blood pressure, body temperature, etc.) of the user.

In an embodiment, the server device 150 may transmit information relating to a guide screen to at least one of the user device 110, the exercise device 120, the imaging device 130, and the display device 140. The user may receive a guide screen via at least one of the user device 110, the exercise device 120, the imaging device 130, and the display device 140.

In an embodiment, although not shown in the drawings, the server device 150 may be connected to various types of smart electronic devices (e.g., an air conditioner and an air purifier) that may exist in the user's exercise environment 100, and may control air-conditioning states so that the user can exercise in an optimal environment.

According to an embodiment, when the user device 110 operates in a privacy mode instead of a server mode, the user device 110, the exercise device 120, the imaging device 130, and the display device 140 may communicate data with each other without going via the server device 150.

In an embodiment, the user device 110 may perform mutual data communication with the exercise device 120 using short-range wireless communication (e.g., Bluetooth, near field communication (NFC), wireless fidelity (Wi-Fi)) or long-range wireless communication technology.

In an embodiment, when the user device 110 approaches the exercise device 120 by a distance less than or equal to a predetermined distance, identification information of a user intending to exercise may be transmitted to the exercise device 120 via NFC. The exercise device 120 may identify the user based on the identification information of the user received from the user device 110, and may identify body information of the user and information relating to exercise history of the user.

In an embodiment, the user device 110 may transmit, to the exercise device, information relating to exercise conditions of the user (e.g., exercise settings) and body information of the user (e.g., height, weight, body composition information, heart rate, body temperature, blood pressure).

In an embodiment, the user device 110 may receive, from the exercise device 120, body information of the user (e.g., information relating to height and weight, body composition information such as body fat percentage and skeletal muscle mass) and exercise information (e.g., type of exercise performed, weight, number of repetitions (reps), and speed). Depending on the number and types of sensors included in the user device 110 and the exercise device 120, measurable body information in the user device 110 and the exercise device 120 may differ from body information measurable in the exercise device 120. For example, when the user device 110 does not have a sensor capable of identifying weight and height of the user, the user device 110 may receive information relating to weight and height of the user from the exercise device 120. For example, when the exercise device 120 does not have a sensor for measuring body temperature, blood pressure, and heart rate of the user, the exercise device 120 may receive the information from the user device 110.

In an embodiment, the exercise device 120 may generate information relating to recommended exercise and information relating to capturing conditions based on information relating to exercise conditions of the user and body information of the user received from the user device 110. The recommended exercise information may include information relating to an exercise that is determined by the user based on body information of the user and information relating to exercise history of the user. The recommended exercise information may include information relating to the type of exercise, weight, and number of repetitions.

In an embodiment, the user device 110 may transmit information relating to the user to the imaging device 130. For example, the user device 110 may transmit body information of the user (e.g., height, posture, etc.) to the imaging device 130, and the imaging device 130 may capture the user based on the body information received from the user device 110.

In an embodiment, the imaging device 130 may receive, from the exercise device 120, recommended exercise information and information relating to capturing conditions. The imaging device may determine a region of the user's body to capture (e.g., upper body or lower body focus, front focus or rear focus) according to the recommended exercise information received from the exercise device 120, and may move to a position to capture based on the information relating to capturing conditions, and may capture the user (e.g., if the condition is to perform capturing in a clockwise direction starting from the rear, capturing may be performed accordingly). The imaging device 130 may transmit, to the exercise device 120, captured data obtained by capturing the user.

In an embodiment, the exercise device 120 may generate information relating to a guide screen based on the captured data received from the imaging device 130. The information relating to the guide screen may include information relating to a correct exercise posture, information relating to a current exercise posture of the user, and body information of the user.

In an embodiment, at least one of the user device 110, the exercise device 120, the imaging device 130, and the display device 140 may display a guide screen based on information relating to the guide screen generated by the exercise device 120. For example, when displaying a guide screen via the user device 110, the imaging device 130, and the display device 140, the exercise device 120 may transmit information relating to the generated guide screen to at least one of the user device 110, the exercise device 120, and the display device 140.

In an embodiment, the display device 140 may capture an exercise posture of the user by using at least one sensor included in the display device 140. The display device 140 may transmit, to the exercise device 120, captured data obtained by capturing.

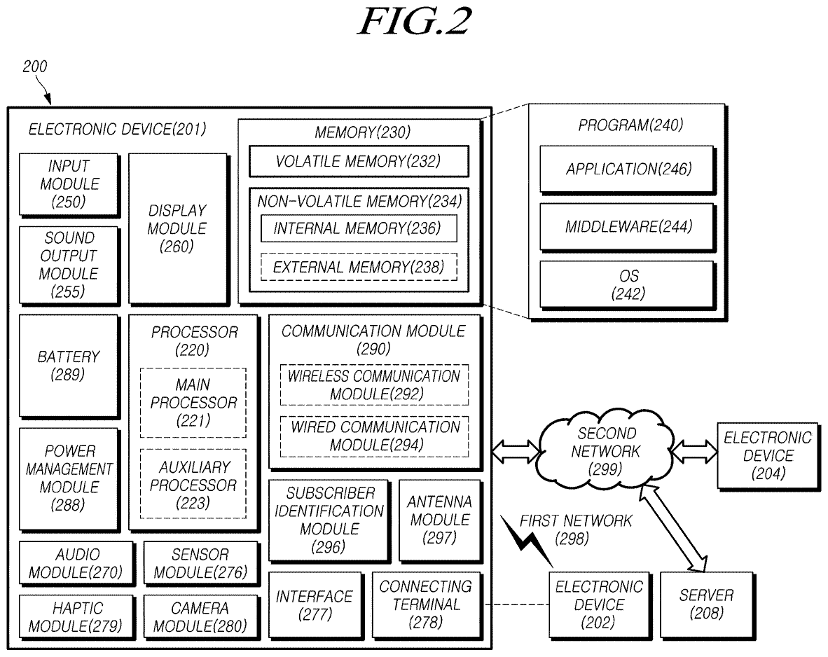

FIG. 2 is a block diagram illustrating an electronic device 201 in a network environment 200 according to an embodiment of the disclosure.

Referring to FIG. 2, the electronic device 201 in the network environment 200 may communicate with an electronic device 202 via a first network 298 (e.g., a short-range wireless communication network), or at least one of an electronic device 204 or a server 208 via a second network 299 (e.g., a long-range wireless communication network). According to an embodiment, the electronic device 201 may communicate with the electronic device 204 via the server 208. According to an embodiment, the electronic device 201 may include a processor 220, memory 230, an input module 250, a sound output module 255, a display module 260, an audio module 270, a sensor module 276, an interface 277, a connecting terminal 278, a haptic module 279, a camera module 280, a power management module 288, a battery 289, a communication module 290, a subscriber identification module (SIM) 296, or an antenna module 297. In some embodiments, at least one of the components (e.g., the 22connecting terminal 278) may be omitted from the electronic device 201, or one or more other components may be added in the electronic device 201. In some embodiments, some of the components (e.g., the sensor module 276, the camera module 280, or the antenna module 297) may be implemented as a single component (e.g., the display module 260). 22

The processor 220 may execute, for example, software (e.g., a program 240) to control at least one other component (e.g., a hardware or software component) of the electronic device 201 coupled with the processor 220, and may perform various data processing or computation. According to one embodiment, as at least part of the data processing or computation, the processor 220 may store a command or data received from another component (e.g., the sensor module 276 or the communication module 290) in volatile memory 232, process the command or the data stored in the volatile memory 232, and store resulting data in non-volatile memory 234. According to an embodiment, the processor 220 may include a main processor 221 (e.g., a central processing unit (CPU) or an application processor (AP)), or an auxiliary processor 223 (e.g., a graphics processing unit (GPU), a neural processing unit (NPU), an image signal processor (ISP), a sensor hub processor, or a communication processor (CP)) that is operable independently from, or in conjunction with, the main processor 221. For example, when the electronic device 201 includes the main processor 221 and the auxiliary processor 223, the auxiliary processor 223 may be adapted to consume less power than the main processor 221, or to be specific to a specified function. The auxiliary processor 223 may be implemented as separate from, or as part of the main processor 221.

The auxiliary processor 223 may control at least some of functions or states related to at least one component (e.g., the display module 260, the sensor module 276, or the communication module 290) among the components of the electronic device 201, instead of the main processor 221 while the main processor 221 is in an inactive (e.g., sleep) state, or together with the main processor 221 while the main processor 221 is in an active state (e.g., executing an application). According to an embodiment, the auxiliary processor 223 (e.g., an image signal processor or a communication processor) may be implemented as part of another component (e.g., the camera module 280 or the communication module 290) functionally related to the auxiliary processor 223. According to an embodiment, the auxiliary processor 223 (e.g., the neural processing unit) may include a hardware structure specified for artificial intelligence model processing. An artificial intelligence model may be generated by machine learning. Such learning may be performed, e.g., by the electronic device 201 where the artificial intelligence is performed or via a separate server (e.g., the server 208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 230 may store various data used by at least one component (e.g., the processor 220 or the sensor module 276) of the electronic device 201. The various data may include, for example, software (e.g., the program 240) and input data or output data for a command related thereto. The memory 230 may include the volatile memory 232 or the non-volatile memory 234. The non-volatile memory 234 may include internal memory 236 and/or external memory 238.

The program 240 may be stored in the memory 230 as software, and may include, for example, an operating system (OS) 242, middleware 244, or an application 246.

The input module 250 may receive a command or data to be used by another component (e.g., the processor 220) of the electronic device 201, from the outside (e.g., a user) of the electronic device 201. The input module 250 may include, for example, a microphone, a mouse, a keyboard, a key (e.g., a button), or a digital pen (e.g., a stylus pen).

The sound output module 255 may output sound signals to the outside of the electronic device 201. The sound output module 255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 260 may visually provide information to the outside (e.g., a user) of the electronic device 201. The display module 260 may include, for example, a display, a hologram device, or a projector and control circuitry to control a corresponding one of the display, hologram device, and projector. According to an embodiment, the display module 260 may include a touch sensor adapted to detect a touch, or a pressure sensor adapted to measure the intensity of force incurred by the touch.

The audio module 270 may convert a sound into an electrical signal and vice versa. According to an embodiment, the audio module 270 may obtain the sound via the input module 250, or output the sound via the sound output module 255 or a headphone of an external electronic device (e.g., an electronic device 202) directly (e.g., wiredly) or wirelessly coupled with the electronic device 201.

The sensor module 276 may detect an operational state (e.g., power or temperature) of the electronic device 201 or an environmental state (e.g., a state of a user) external to the electronic device 201, and then generate an electrical signal or data value corresponding to the detected state. According to an embodiment, the sensor module 276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 277 may support one or more specified protocols to be used for the electronic device 201 to be coupled with the external electronic device (e.g., the electronic device 202) directly (e.g., wiredly) or wirelessly. According to an embodiment, the interface 277 may include, for example, a high definition multimedia interface (HDMI), a universal serial bus (USB) interface, a secure digital (SD) card interface, or an audio interface.

A connecting terminal 278 may include a connector via which the electronic device 201 may be physically connected with the external electronic device (e.g., the electronic device 202). According to an embodiment, the connecting terminal 278 may include, for example, a HDMI connector, a USB connector, a SD card connector, or an audio connector (e.g., a headphone connector).

The haptic module 279 may convert an electrical signal into a mechanical stimulus (e.g., a vibration or a movement) or electrical stimulus which may be recognized by a user via his tactile sensation or kinesthetic sensation. According to an embodiment, the haptic module 279 may include, for example, a motor, a piezoelectric element, or an electric stimulator.

The camera module 280 may capture a still image or moving images. According to an embodiment, the camera module 280 may include one or more lenses, image sensors, image signal processors, or flashes.

The power management module 288 may manage power supplied to the electronic device 201. According to one embodiment, the power management module 288 may be implemented as at least part of, for example, a power management integrated circuit (PMIC).

The battery 289 may supply power to at least one component of the electronic device 201. According to an embodiment, the battery 289 may include, for example, a primary cell which is not rechargeable, a secondary cell which is rechargeable, or a fuel cell.

The communication module 290 may support establishing a direct (e.g., wired) communication channel or a wireless communication channel between the electronic device 201 and the external electronic device (e.g., the electronic device 202, the electronic device 204, or the server 208) and performing communication via the established communication channel. The communication module 290 may include one or more communication processors that are operable independently from the processor 220 (e.g., the application processor (AP)) and supports a direct (e.g., wired) communication or a wireless communication. According to an embodiment, the communication module 290 may include a wireless communication module 292 (e.g., a cellular communication module, a short-range wireless communication module, or a global navigation satellite system (GNSS) communication module) or a wired communication module 294 (e.g., a local area network (LAN) communication module or a power line communication (PLC) module). A corresponding one of these communication modules may communicate with the external electronic device via the first network 298 (e.g., a short-range communication network, such as Bluetooth™, wireless-fidelity (Wi-Fi) direct, or infrared data association (IrDA)) or the second network 299 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 292 may identify and authenticate the electronic device 201 in a communication network, such as the first network 298 or the second network 299, using subscriber information (e.g., international mobile subscriber identity (IMSI)) stored in the subscriber identification module 296.

The wireless communication module 292 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 292 may support a high-frequency band (e.g., the millimeter wave (mmWave) band) to achieve, e.g., a high data transmission rate. The wireless communication module 292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 292 may support various requirements specified in the electronic device 201, an external electronic device (e.g., the electronic device 204), or a network system (e.g., the second network 299). According to an embodiment, the wireless communication module 292 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 297 may transmit or receive a signal or power to or from the outside (e.g., the external electronic device) of the electronic device 201. According to an embodiment, the antenna module 297 may include an antenna including a radiating element composed of a conductive material or a conductive pattern formed in or on a substrate (e.g., a printed circuit board (PCB)). According to an embodiment, the antenna module 297 may include a plurality of antennas (e.g., array antennas). In such a case, at least one antenna appropriate for a communication scheme used in the communication network, such as the first network 298 or the second network 299, may be selected, for example, by the communication module 290 (e.g., the wireless communication module 292) from the plurality of antennas. The signal or the power may then be transmitted or received between the communication module 290 and the external electronic device via the selected at least one antenna. According to an embodiment, another component (e.g., a radio frequency integrated circuit (RFIC)) other than the radiating element may be additionally formed as part of the antenna module 297. According to various embodiments, the antenna module 297 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 201 and the external electronic device 204 via the server 208 coupled with the second network 299. Each of the electronic devices 202 or 204 may be a device of the same type as, or a different type, from the electronic device 201. According to an embodiment, all or some of operations to be executed at the electronic device 201 may be executed at one or more of the external electronic devices 202, 204, or server 208. For example, if the electronic device 201 should perform a function or a service automatically, or in response to a request from a user or another device, the electronic device 201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 201. The electronic device 201 may provide the outcome, with or without further processing of the outcome, as at least part of a reply to the request. To that end, a cloud computing, distributed computing, mobile edge computing (MEC), or client-server computing technology may be used, for example. The electronic device 201 may provide ultra low-latency services using, e.g., distributed computing or mobile edge computing. In another embodiment, the external electronic device 204 may include an internet-of-things (IoT) device. The server 208 may be an intelligent server using machine learning and/or a neural network. According to an embodiment, the external electronic device 204 or the server 208 may be included in the second network 299. The electronic device 201 may be applied to intelligent services (e.g., smart home, smart city, smart car, or healthcare) based on 5G communication technology or IoT-related technology.

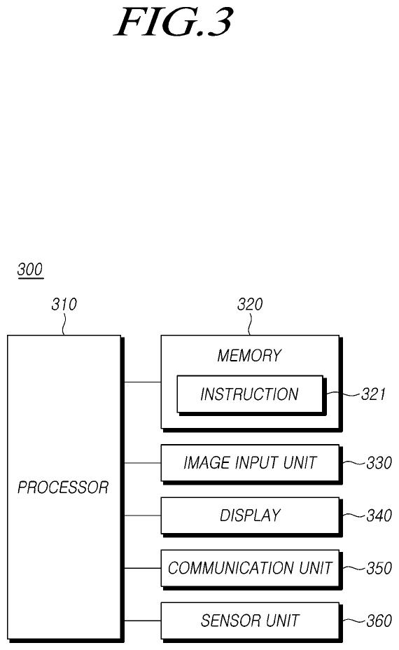

FIG. 3 illustrates a block diagram of a display device according to an embodiment of the disclosure. The display device may include a display device (e.g., a TV, a monitor) for displaying an image.

According to an embodiment, the display device 300 may include a processor 310, memory 320, an image input unit 330, a display 340, a communication unit 350, and a sensor unit 360.

According to an embodiment, the memory 320 is a storage medium used by the display device 300 and may store at least one command 321 corresponding to at least one program or data such as configuration information. The program may include an operating system (OS) program and various application programs.

In an embodiment, the memory 320 may store pairing information of an external electronic device located adjacent to the display device 300. In an embodiment, the pairing information may include device information of an external electronic device, information about another external electronic device or a remote control device paired with the external electronic device, information about a method (e.g., Bluetooth, Wi-Fi) in which the external electronic device and another external electronic device or a remote control device are paired, information about a pairing history between the external electronic device and another external electronic device or a remote control device, etc.

In an embodiment, the memory 320 may include at least one type of storage medium of flash memory type, a hard disk type, a multimedia card micro type, card type memory (e.g., SD or extreme digital (XD) memory, etc.), random access memory (RAM), static random access memory (SRAM), read only memory (ROM), electrically erasable programmable ROM (EEPROM), programmable ROM (PROM), magnetic memory, a magnetic disk, or an optical disk.

According to an embodiment, the image input unit 330 may receive an image and image information via a tuner (not shown), an input/output unit (not shown), or the communication unit 350. The image input unit 330 may include at least one of the tuner and the input/output unit. The tuner may select a frequency of a broadcast channel that the display device 300 wants to receive among many radio wave components via amplification, mixing, resonance, etc. of a broadcast signal received wired or wirelessly. The broadcast signal may include video, audio, and supplementary data (e.g., an Electronic Program Guide (EPG)). The tuner may receive real-time broadcast channels (or real-time viewing images) from various broadcast sources such as terrestrial broadcast, cable broadcast, satellite broadcast, and Internet broadcast. The tuner may be implemented integrally with the display device 300 or as a separate tuner electrically connected to the display device 300.

In an embodiment, the image input unit 330 may include at least one of an High Definition Multimedia Interface (HDMI) input port, a component input jack, a personal computer (PC) input port, and a USB input jack that can receive an image and image information from an external device of the display device 300 under the control of the processor 310. It will be apparent to those skilled in the art that the input/output unit may be added, deleted, and/or changed according to the performance and structure of the display device 300.

According to an embodiment, the display 340 may perform functions for outputting information in the form of numbers, characters, images, and/or graphics. The display 340 may include at least one hardware module for output. The at least one hardware module may, for example, include at least one of a Liquid Crystal Display (LCD), a Light Emitting Diode (LED), a Light emitting Polymer Display (LPD), an Organic Light Emitting Diode (OLED), an Active Matrix Organic Light Emitting Diode (AMOLED), or a Flexible LED (FLED). The display 340 may display a screen corresponding to data received from the processor 310. The display 340 may be referred to as an “output unit”, a “display unit”, or another term having equivalent technical meaning thereto. “Screen” may include an image displayed on the display of the display device. An image may be referred to by terms such as a frame. The screen may display various types of objects such as icons, text, photographs, videos, widgets, etc.

According to an embodiment, the communication unit 350 may provide a wired and wireless communication interface that enables communication with an external device. The communication unit 350 may include at least one of a wired Ethernet, a wireless LAN communication unit, and a short-range communication unit. The wireless LAN communication unit may, for example, include Wi-Fi and may support a wireless LAN standard (IEEE 802.11x) of the Institute of Electrical and Electronics Engineers (IEEE). The wireless LAN communication unit may be wirelessly connected to an access point (AP) under the control of the processor 310. An AP may include a device that enables connection of devices using related standards using Wi-Fi in a computer network. The short-range communication unit may perform short-range wireless communication with an external device under the control of the processor 310. Short-range communication may include Bluetooth, Bluetooth Low Energy, infrared data association (IrDA), Ultra Wideband (UWB), and Near Field Communication (NFC), etc. The external device may include a server device providing an image service, etc., and a mobile terminal (e.g., a phone, a tablet, etc.).

According to an embodiment, the processor 310 may execute at least one instruction 321 stored in the memory 320, to perform calculations or data processing related to controlling and/or communication of at least one other component of the display device 300. The processor 310 may include at least one of a central processing unit (CPU), a graphics processing unit (GPU), a Micro Controller Unit (MCU), a sensor hub, a supplementary processor, a communication processor, an application processor, an Application Specific Integrated Circuit (ASIC), or Field Programmable Gate Arrays (FPGA), and may have a plurality of cores.

In an embodiment, the processor 310 may, for example, execute software to control at least one other component (e.g., a hardware or software component) of the display device 300 connected to the processor 310, and may perform various data processing or calculations. According to an embodiment, as at least a part of data processing or calculations, the processor 310 may store a command or data received from another component in volatile memory, process the command or data stored in the volatile memory, and store result data in non-volatile memory. According to an embodiment, the processor 310 may include a main processor (e.g., a central processing unit or an application processor) or an auxiliary processor that may be operated independently from or together with the main processor (e.g., a graphics processing unit, a neural processing unit (NPU), an image signal processor, a sensor hub processor, or a communication processor). For example, when the display device 300 includes a main processor and an auxiliary processor, the auxiliary processor may be set to use lower power than the main processor or to be specialized for a designated function. The auxiliary processor may be implemented separately from the main processor or as a part thereof.

In an embodiment, the processor 310 may obtain video frame data from at least one of the memory 320, the video input unit 330, or the communication unit 350. The processor 310 may receive video frame data from at least one of the memory 320, the video input unit 330, or the communication unit 350. The video frame data may include data relating to frames constituting the video. For example, the video frame data may be identified from the memory 320 (e.g., recorded and stored video). For example, the video frame data may include data obtained from the communication unit 350 or the video input unit 330 (e.g., real-time streaming video).

In an embodiment, the sensor unit 360 may sense a posture of a user performing exercise to obtain captured data. The sensor unit 360 may be located at a front portion of the display device 300. The sensor unit 360 may include a camera, a lidar, an infrared sensor, etc.

In an embodiment, the display device 300 may obtain captured data via the sensor unit 360. The user may be recognized via the sensor unit 360, and the user performing exercise may be captured via the sensor to obtain captured data. For example, when there is no imaging device 130 and the information relating to capturing conditions instructs to capture focusing mainly on the user's front, the captured data may be obtained via the display device 140 rather than the imaging device 130.

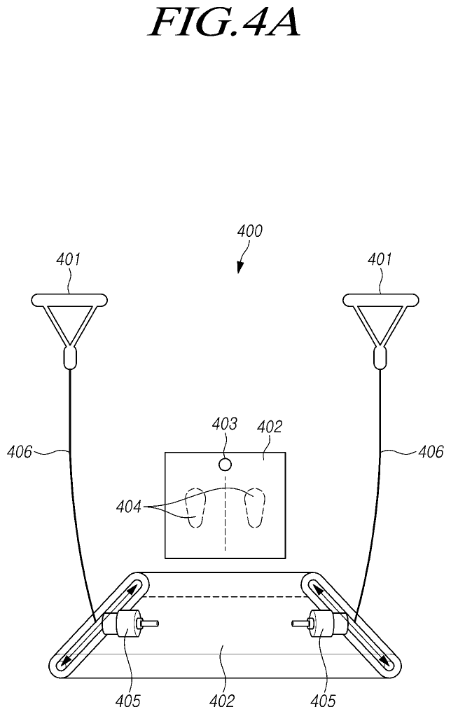

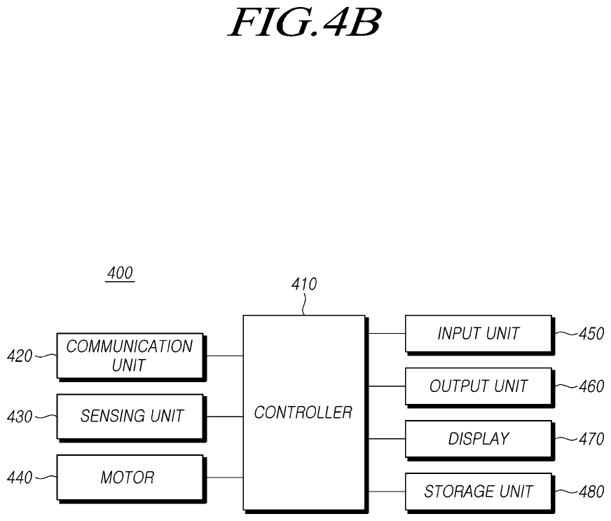

FIG. 4A illustrates an exercise device according to an embodiment of the disclosure. FIG. 4B illustrates a block configuration of an exercise device according to an embodiment of the disclosure.

Referring to FIG. 4A, the exercise device 400 may include a grip portion 401 that a user may grasp using a body part (e.g., a hand), a motor unit 405 capable of moving vertically (in the y-axis direction) by a certain length, and a body portion 402 including a bottom for a body part (e.g., a foot) of the user to contact for performing exercise.

In an embodiment, the exercise device 400 may include at least two grip portions 401. The grip portion 401 may be connected to a cable 406. An electrical signal for measuring body fat percentage, skeletal muscle mass, and the like may be transmitted to the user's body via the grip portion 401, and various other sensors (e.g., a body temperature sensor, a gyro sensor, an acceleration sensor, a horizontal sensor, a grip strength sensor, a haptic sensor, a vibration sensor, etc.) may be included in the grip portion 401.

In an embodiment, the grip portion 401 may include at least one sensor for measuring a physical condition of the user. For example, the at least one sensor may include a temperature sensor for measuring an exercise load and health state (e.g., body temperature) of the user. For example, the at least one sensor may include a gyro sensor, an acceleration sensor, a horizontal sensor, and a grip strength sensor for identifying an exercise state.

In an embodiment, the exercise device 400 may include an infrared (IR) sensor for identifying a user input to remotely control another device (e.g., the imaging device 500, the display device 300).

In an embodiment, the body portion 402 may include a projector 403 for projecting a screen onto a floor or a wall, and a contact portion 404 for contacting a body part (e.g., a foot) of the user to measure body composition of the user.

In an embodiment, the exercise device 400 may project a screen onto the surroundings of the exercise device 400 (e.g., the body portion of the exercise device, a floor adjacent to the exercise device, a wall adjacent to the exercise device, a ceiling that the exercise device faces) using the projector 403. For example, the exercise device 400 may project a guide screen via the projector 403.

In an embodiment, the exercise device 400 may flow electrical signals via the user's foot contacting the contact portion 404 to the user's body, and may generate information relating to body composition of the user based on electrical signals entering again.

In an embodiment, the body portion 402 may include a scale sensor for measuring body weight, calorie consumption, and the like of a user exercising using the exercise device 400.

In an embodiment, the body portion 402 may include a pressure sensor for measuring body balance of a user exercising using the exercise device 400.

In an embodiment, the body portion 402 may include a proximity sensor for identifying a user. For example, when a proximity sensor identifies that an object of a predetermined condition is adjacent to the exercise device 400, the exercise device 400 may determine that a user intending to perform exercise has boarded the exercise device 400.

In an embodiment, the body portion 402 may include a resistant power motor module for measuring an exercise state of the user. Additionally, the body portion 402 may include a body composition sensor for measuring user's body fat mass, skeletal muscle mass, body water content, visceral fat mass, etc.

In an embodiment, the motor unit 405 may be connected by wire to the grip portion 401 via the cable 406.

In the following description, the grip portion 401 and the body portion 402 are described as an example of being connected by wire, but this is merely an example, and the grip portion 401 and the body portion 402 may be implemented as separate independent devices. In other words, the grip portion 401 and the body portion 402 may be connected wirelessly. For example, the exercise device 400 may not include the motor unit 405. In such a case, the grip portion 401 may be connected to the body portion 402 using wireless communication technology (e.g., BLE, Wi-Fi).

In an embodiment, the grip portion 401 and the cable 406 may be separated.

In an embodiment, the body portion 402 itself may be configured as a display panel, and a screen may be displayed via the body portion 402.

Referring to FIG. 4B, the exercise device 400 may include a control unit 410, a communication unit 420, a sensing unit 430, a motor 440, an input unit 450, an output unit 460, a display unit 470, and a storage unit 480.

In an embodiment, the exercise device 400 may control operations of the communication unit 420, the sensing unit 430, the motor 440, the input unit 450, the output unit 460, the display unit 470, and the storage unit 480 via the control unit 410.

In an embodiment, the control unit 410 may generate data for generating a guide screen based on information identified from the communication unit 420, the sensing unit 430, the motor 440, the input unit 450, the output unit 460, and the storage unit 480. For example, the control unit 410 may generate data relating to recommended exercise information of the user based on data received from the user device 110 or the server device 150 (e.g., body information of the user (information relating to current physical condition of the user, such as heart rate, body temperature, blood pressure), information relating to exercise history of the user (e.g., information relating to types of exercise performed during a predetermined period, exercise performance capability (e.g., weight performed, number of times, speed))). For example, the control unit 410 may generate information relating to capturing conditions based on data received from the user device 110 or the server device 150 and the recommended exercise information. The information relating to capturing conditions may include a position to capture the user, a region to capture, an angle of a camera, and a field of view and focus information based on at least one sensor (e.g., a camera, a lidar sensor, etc.) included in the imaging device 130 or the display device 140. In the following description, an example is given in which the control unit 410 generates data necessary for generating a guide screen, but this is merely an example, and related information may be generated in another device. For example, the server device 150 may also generate data necessary for generating a guide screen, and the imaging device 130, the user device 110, and the display device 140 may also generate data.

In an embodiment, the exercise device 400 may transmit data generated in the exercise device 400 to another device via the communication unit 420, and may receive data generated from another device. For example, the exercise device 400 may transmit recommended exercise information and information relating to capturing conditions to the imaging device 130 via the communication unit 420. For example, the exercise device 400 may receive captured data obtained by the imaging device 130 via the communication unit 420. For example, the exercise device 400 may receive data relating to body information of the user obtained by the user device 110 via the communication unit 420.

In an embodiment, the exercise device 400 may sense information relating to body information and exercise state of the user via the sensing unit 430. For example, the exercise device 400 may sense body temperature of the user using a body temperature sensor. For example, the exercise device 400 may sense data relating to exercise posture for determining whether exercise performed by the user is accurate using at least one of a gyro sensor, an acceleration sensor, or a horizontal sensor. For example, the exercise device 400 may remotely control another device using an IR sensor. For example, the exercise device 400 may sense grip strength of the user and other exercise information according to grip strength using a grip strength sensor. For example, the exercise device 400 may sense information relating to exercise posture of the user using a vibration sensor. For example, the exercise device 400 may sense body information (body weight, balance, body fat mass, skeletal muscle mass, etc.) of the user using a scale sensor, a pressure sensor, and a body composition measurement sensor. For example, the exercise device 400 may identify a user who has boarded the exercise device 400 using a proximity sensor.

In an embodiment, the exercise device 400 may identify information relating to an exercise state of the user by the motor 440. The motor 440 may be connected to a hand grip held by the user. Through movement of the motor 440 and current data measured by the motor, the exercise device 400 may identify information relating to an exercise state of the user.

In an embodiment, the exercise device 400 may identify a user input via the input unit 450. For example, the input unit 450 may include a microphone and a camera.

In an embodiment, the exercise device 400 may output information generated in the exercise device 400 or another device via the output unit 460. For example, the exercise device 400 may output information relating to a guide screen via a display of the exercise device 400 (e.g., when the body portion 402 is configured as a display panel, the body portion 402 may directly operate as a display) or via the projector 403. For example, the exercise device 400 may output sound for guiding exercise of the user via the output unit 460. For example, the exercise device 400 may provide haptic feedback via a haptic module of the output unit 460. For example, the exercise device 400 may output light via the output unit 460.

In an embodiment, the exercise device 400 may display information relating to a guide screen via the display unit 470. For example, information relating to a guide screen may be displayed via at least one of the body portion 402 of the exercise device 400 or the projector 403 included in the body portion 402 of the exercise device 400.

In one embodiment, the exercise device 400 may store data generated via the controller 410 in the storage unit 480, and data received from other devices (e.g., the user device 110, the imaging device 130, the display device 140, and the server device 150).

In addition, the exercise device 400 may include a power supply unit (not shown) for receiving power from an external power source, and an auxiliary power source (not shown) for supplying power to the exercise device 400 when power is not supplied via the power supply unit (not shown).

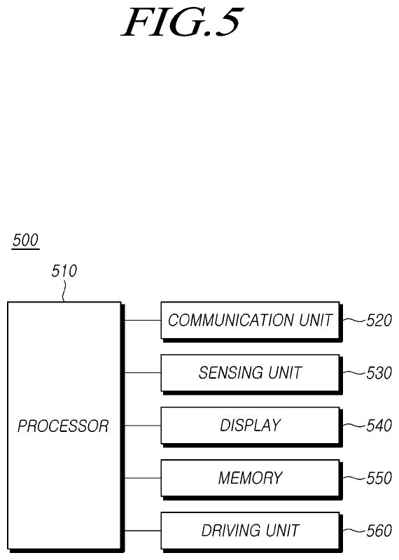

FIG. 5 illustrates a block configuration of an imaging device according to an embodiment of the disclosure. The imaging device 500 of FIG. 5 may include a device corresponding to the imaging device 130 of FIGS. 1A and 1B.

Referring to FIG. 5, the imaging device 500 according to an embodiment may include a processor 510, a communication unit 520, a sensing unit 530, a display unit 540, memory 550, and a locomotion unit 560. The imaging device may include, for example, a robotic vacuum cleaner having a camera.

In one embodiment, the imaging device 500 may control the operation of the communication unit 520, the sensing unit 530, the display unit 540, the memory 550, and the locomotion unit 560 via the processor 510.

In one embodiment, the communication unit 520 may perform data communication with other devices (e.g., the user device 110), the exercise device 400, and the display device 300.

In one embodiment, the sensing unit 530 may include a camera, a LIDAR sensor, an infrared sensor, etc. The imaging device 500 may identify the location of the user, a distance from the user, a posture of the user, a body part of the user, and the like via the sensing unit 530, and obtain captured data.

In one embodiment, the display unit 540 may include a display and a projection unit. For example, the display unit 540 may include a display section configured as a display panel included in the imaging device 500. For example, the display unit 540 may include a projection unit (e.g., a projector) for projecting data regarding a screen generated in the imaging device 500 to the outside.

In one embodiment, the memory 550 may store data generated in the imaging device 500 and data received from other devices.

In one embodiment, the locomotion unit 560 may include a motor and a power unit included in the imaging device 500 to enable the imaging device 500 to move to a specific location.

The imaging device 500 illustrated and described below in the drawings is merely an example, and the imaging device 500 may have a shape and size different from the shape and size illustrated in the drawings.

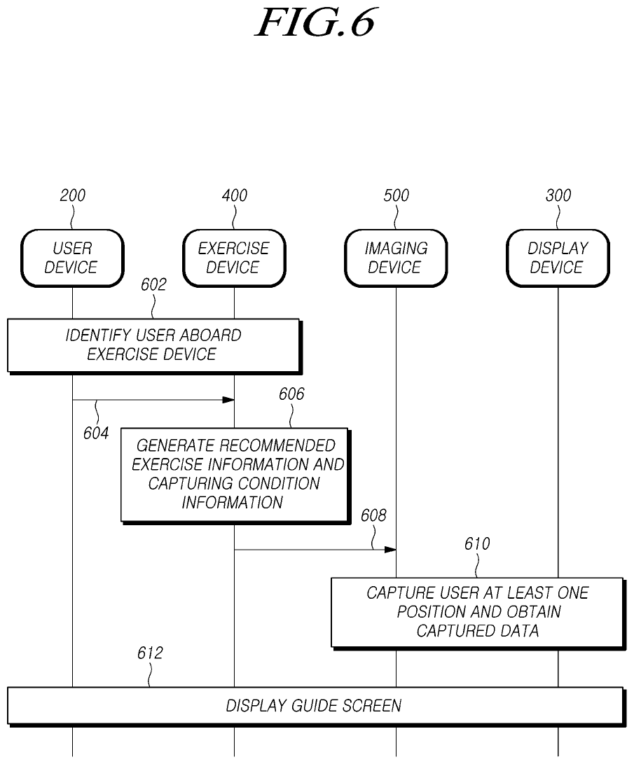

FIG. 6 illustrates a signaling flow of the user device 200, the exercise device 400, the imaging device 500, and the display device 300 according to an embodiment of the disclosure.

According to an embodiment, in operation 602, the user device 200 and the exercise device 400 may identify a user riding on the exercise device 400.

In one embodiment, when the exercise device 400 receives a predetermined signal from the user device 200, the exercise device 400 may determine that a user has boarded the exercise device 400. For example, when the exercise device 400 receives a predetermined signal from the user device 200 using a short-range wireless communication technology (e.g., BLE, Wi-Fi, NFC), the exercise device 400 may determine that a user has boarded the exercise device 400. The predetermined signal may include identification information of the user device 200, and the exercise device 400 may determine whether there is information about the user (e.g., information about the user's exercise history) previously stored in the exercise device or the server device based on the identification information.

In one embodiment, when the exercise device 400 identifies that the user device 200 approaches within a predetermined range, the exercise device 400 may determine that a user has boarded the exercise device 400. For example, the exercise device 400 may identify that the user device 200 approaches within a predetermined range via at least one sensor (e.g., a proximity sensor). In such a case, the exercise device 400 may determine that a user has boarded the exercise device 400.

In one embodiment, when the exercise device 400 detects a weight equal to or greater than a predetermined weight via at least one sensor of the exercise device 400, the exercise device 400 may determine that a user has boarded the exercise device 400.

In one embodiment, when the exercise device 400 identifies a user input indicating that a user has boarded via an input unit, the exercise device 400 may determine that a user has boarded the exercise device 400.

In one embodiment, the exercise device may recognize at least a portion of the body of the user via a camera. The exercise device may identify the user based on at least a portion of the body of the user.

According to an embodiment, in operation 604, the user device 200 may transmit first physical condition information to the exercise device 400. The first physical condition information may include information about the physical condition of the user measured via a sensor included in the user device 200. For example, the first physical condition information may include the user's heart rate, body temperature, blood pressure, activity level (e.g., calories burned, number of steps, distance traveled).

In one embodiment, the user device 200 may transmit not only the first physical condition information but also information about the user's exercise history to the exercise device 400. The information about the user's exercise history may include information generated based on data about exercises performed by the user for a predetermined period. For example, the information about the user's exercise history may include information regarding the types of exercises performed by the user, the types of exercises not performed by the user, and the user's physical characteristics (e.g., injury history).

According to an embodiment, in operation 606, the exercise device 400 may generate recommended exercise information and capturing condition information. The exercise device 400 may generate the recommended exercise information and the capturing condition information based on the first physical condition information received from the user device 200.

In one embodiment, the recommended exercise information may include information about an exercise recommended to a user riding on the exercise device 400. The recommended exercise information may include the type of exercise recommended and intensity (e.g., weight, number of repetitions). The exercise device 400 may determine the user's physical condition and exercise performance capability based on the first physical condition information and information about the user's exercise history received from the user device 200, and may determine the type and intensity of exercise suitable for the user via a predetermined rule or a machine learning model based thereon. For example, when the user's blood pressure is equal to or greater than a predetermined value, the exercise intensity may be set low to recommend a light aerobic exercise as the recommended exercise. For example, when the user's activity level is equal to or less than a predetermined value, a high-intensity strength exercise may be recommended as the recommended exercise to increase the activity level.

In one embodiment, the capturing condition information may include information about conditions for capturing by the imaging device 500 that captures a user performing an exercise via the exercise device 400. The capturing condition information may include information about a capturing location, a capturing part, and a movement path for capturing the user. For example, when the user faces forward and the recommended exercise information includes an upper body exercise, the capturing condition information may include the user's front as the capturing location and the user's upper body as the capturing part.

In one embodiment, although not illustrated in the drawings, the exercise device 400 may generate second physical condition information of the user. The second physical condition information may include information about the physical condition of the user identified via the exercise device 400. For example, the second physical condition information may include body composition information such as the user's height, weight, skeletal muscle mass, and body fat mass, and information regarding basic physical fitness.

In one embodiment, the exercise device 400 may generate data about the user's basic physical fitness and muscular strength based on data obtained when the user performs a predetermined exercise program via the exercise device 400. Recommended exercise information may be generated based on data about the user's basic physical fitness and muscular strength.

According to an embodiment, in operation 608, the exercise device 400 may transmit the recommended exercise information generated in operation 606 and information about the capturing conditions to the imaging device 500.

In one embodiment, the exercise device 400 may transmit the second physical condition information measured in the exercise device 400 to the imaging device 500.

According to an embodiment, in operation 610, the imaging device 500 and the display device 300 may capture the user at at least one location and obtain captured data.

In one embodiment, the at least one location may be determined based on information about capturing conditions received from the exercise device 400.

In one embodiment, the imaging device 500 may capture the user based on information about the capturing conditions. For example, when the recommended exercise information includes a chest exercise, the capturing condition may be determined by capturing the upper body of the user from the front of the user at a location separated by a predetermined distance. For example, when the recommended exercise information includes a shoulder exercise, the capturing conditions may be determined to capture the user's upper body by moving from the front-side-back-front of the user at a location separated by a predetermined distance.

In one embodiment, the captured data may include at least one image or video data.

In one embodiment, when the display device 300 comprises at least one sensor (e.g., a camera) capable of capturing the user, the display device 300 may capture the user and obtain the captured data.

In one embodiment, at least a part of the captured data may be captured at the display device 300. For example, when the display device 300 is disposed at the front of the user, the display device 300 may capture the front of the user and obtain a front image or video, and the imaging device 500 may capture the side and rear of the user excluding the front and obtain a side and rear image or video.

In one embodiment, the imaging device 500 may capture the user and analyze the user's exercise posture. For example, the imaging device 500 may capture the user based on information relating to the capturing condition, and generate information on the user's exercise performance (e.g., information relating to an angle of the body, inclination, performance speed, and tremor) based on the captured data. The imaging device 500 may generate feedback information on the user's exercise based on information on the user's exercise performance. For example, an error and accuracy in the user's exercise performance may be measured. For example, when the imaging device 500 identifies via the captured data that the user should perform exercise with a straightened back, but the user performs exercise with a bent back, the feedback information may include information notifying that the user should straighten the back.

In one embodiment, the imaging device 500 and the display device 300 may transmit the captured data to the exercise device 400. The exercise device 400 may change the exercise setting based on the captured data received from the imaging device 500 or the display device 300. In one embodiment, the exercise device 400 may change the recommended exercise based on the user's physical condition information identified while the user performs exercise. In such case, the exercise device 400 may transmit the changed recommended exercise information and information relating to the capturing condition to the imaging device 500. In other words, the imaging device 500 and the exercise device 400 may monitor in real time the user's exercise state (e.g., the exercise device 400 monitors the user's physical condition, and the imaging device 500 monitors the user's exercise posture), and exchange information relating thereto to provide feedback according to the user's physical condition and exercise posture in real time.

In one embodiment, the exercise device may identify a change in resistance of the motor of the exercise device and identify the user's exercise state. The exercise device may modify the recommended exercise information based on the exercise state identified accordingly.

In one embodiment, the exercise device may update the exercise information based on at least one of the first physical condition information, the second physical condition information obtained via at least one sensor, and the captured data. The second physical condition information may include information relating to the user's physical condition identified via a sensor comprised in the exercise device.

According to one embodiment, in operation 612, the user device 200, the exercise device 400, the imaging device 500, and the display device 300 may display a guide screen.

In one embodiment, the exercise device 400 may generate information relating to the guide screen based on the captured data. The information relating to the guide screen may include demonstration video data, an exercise video of the current user, and physical condition information of the user (e.g., heart rate, body temperature, blood pressure, etc.). In the following description, the example of the exercise device 400 generating the information relating to the guide screen is illustrated, but this is only an example, and the information relating to the guide screen may be generated not only in the exercise device 400 but also in the imaging device 500.

In one embodiment, the exercise device 400 may directly display the information relating to the generated guide screen. For example, the guide screen may be displayed on a screen or a body part of the exercise device 400 via a projector comprised in the exercise device 400.

In one embodiment, the exercise device 400 may transmit the information relating to the generated guide screen to at least one of the user device 200, the exercise device 400, and the display device 300. A device that receives the information relating to the guide screen may display the information relating to the guide screen.

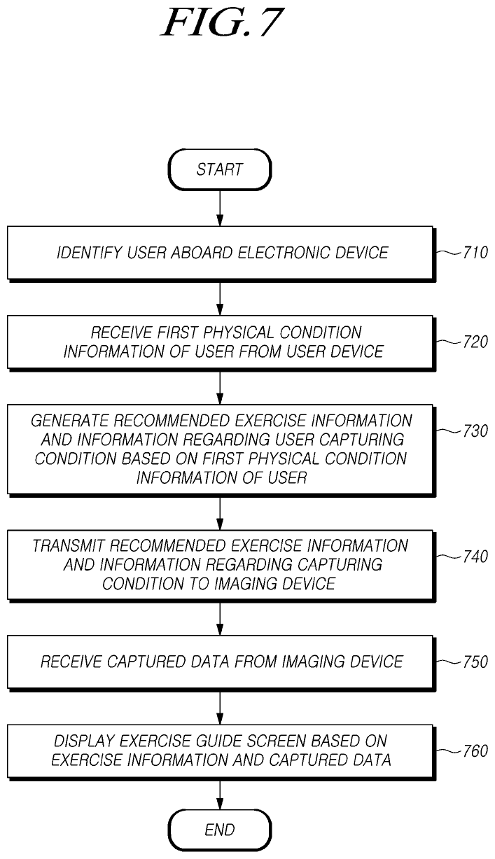

FIG. 7 illustrates an operation flow of an electronic device according to an embodiment of the disclosure. The electronic device of FIG. 7 may include a device corresponding to the exercise device 400. In the description relating to FIG. 7 and the drawings described below, the electronic device may include a device corresponding to the exercise device 400.

According to one embodiment, in operation 710, the electronic device may identify a user device located adjacent to the electronic device using at least one of at least one sensor and a communication unit. The operation content according to operation 710 may include all the operation content described in operation 602 of FIG. 6.

In one embodiment, the electronic device may identify a user mounted on the electronic device via at least one sensor.

In one embodiment, the electronic device may identify a user mounted on the electronic device based on a signal received from the user device via a communication unit.

According to one embodiment, in operation 720, the electronic device may receive the user's first physical condition information from the user device. Operation 720 may include all the operation content described in operation 604 of FIG. 6.

In one embodiment, the first physical condition information may include information relating to the user's physical condition measured via a sensor included in the user device 200. For example, the first physical condition information may include information relating to the user's heart rate, body temperature, blood pressure, activity amount (e.g., calories burned, number of steps, distance traveled), oxygen saturation, etc.

In one embodiment, the user device may transmit to the electronic device not only the first physical condition information but also information relating to the user's exercise history. The information relating to the user's exercise history may include information generated based on data relating to exercise performed by the user during a predetermined period. For example, the information relating to the user's exercise history may include information relating to the type of exercise performed by the user, the type of exercise not performed by the user, and a physical characteristic of the user (e.g., injury history).

According to one embodiment, in operation 730, the electronic device may generate recommended exercise information and information relating to user capturing condition based on the user's first physical condition information.

In one embodiment, the electronic device may generate recommended exercise information and capturing condition information. The electronic device may generate recommended exercise information and capturing condition information based on the first physical condition information received from the user device.

In one embodiment, the recommended exercise information may include information relating to an exercise recommended to a user mounted on the electronic device. The recommended exercise information may include a type of the recommended exercise and intensity (e.g., weight, number of repetitions). The electronic device may determine the user's condition and ability to perform exercise based on the first physical condition information and information relating to exercise history received from the user device, and determine a type and intensity of exercise suitable for the user via a predetermined rule or a machine learning model based thereon. For example, when the user's blood pressure is greater than or equal to a predetermined value, the exercise intensity may be set low to determine light aerobic exercise as the recommended exercise. For example, when the user's activity amount is less than or equal to a predetermined value, high-intensity strength exercise may be determined as the recommended exercise to increase the activity amount.

In one embodiment, the capturing condition information may include information relating to conditions for capturing by an imaging device that captures a user performing exercise via the electronic device. The capturing condition information may include information relating to a capturing position, a capturing region, and a movement path along which the user is captured. For example, when the recommended exercise is determined such that the user looks forward and performs upper-body-focused exercise, the information relating to the capturing condition may include the front of the user as the capturing position and the upper body of the user as the capturing region.

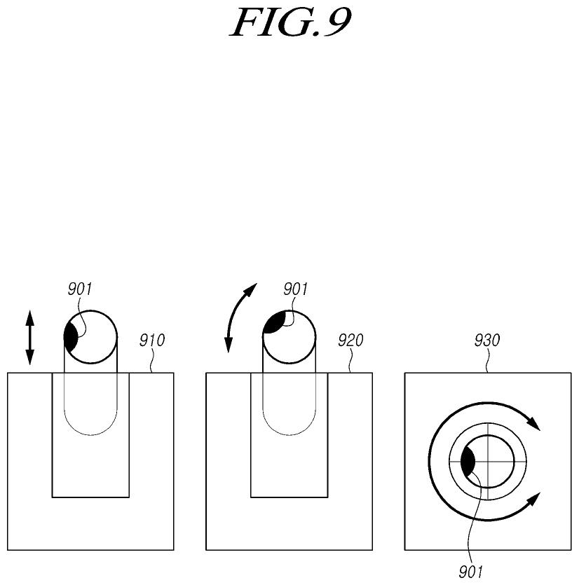

FIG. 9 illustrates an example of an operation of a sensor included in an electronic device according to an embodiment of the disclosure. The electronic device of FIG. 9 may include a device corresponding to the imaging device 500. The sensor of FIG. 9 may include a sensing unit 530 of FIG. 5.

Referring to FIG. 9, an example of a sensor operating differently for an imaging device to capture a user according to the capturing condition information is illustrated.

In one embodiment, the sensor 901 may move up and down in the first operation 910 and capture the user by elevation. In other words, the capturing height may be varied.

In one embodiment, the sensor 901 may capture the user via a tilt operation in a second operation 920. For example, the sensor 901 may perform the second operation 920 such that the sensor faces the lower body of the user in order to capture a user performing lower-body exercise. For example, the sensor 901 may perform the second operation 920 such that the sensor faces the upper body of the user in order to capture a user performing upper-body exercise.

In one embodiment, the sensor 901 may rotate and capture the user via a swivel operation in a third operation 930.

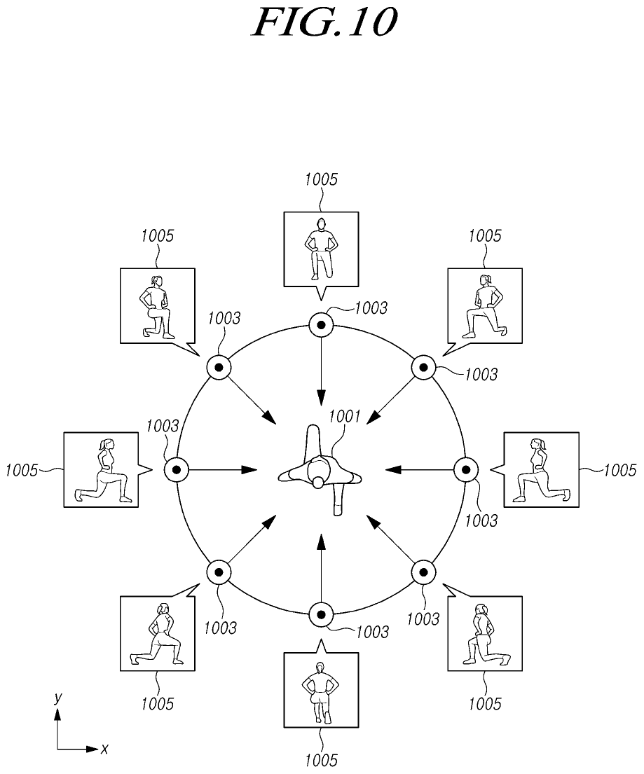

FIG. 10 illustrates an example of capturing user by an imaging device according to an embodiment of the disclosure. The imaging device 1003 of FIG. 10 may include a device corresponding to the imaging device 500.

In one embodiment, the imaging device may capture a user performing exercise in the exercise device based on information relating to the capturing condition. The imaging device may capture the user at a position indicated in the capturing condition.

Referring to FIG. 10, the imaging device 1003 may capture a user 1001 performing exercise via the exercise device at a plurality of positions and obtain captured data 1005. The +y direction may include a front direction of the user. The −y direction may include a rear direction of the user. The +x direction may include a right direction of the user. The −x direction may include a left direction of the user.

Although shown in the drawing as performing capturing at only one predetermined length from the user, this is merely an example, and the imaging device may capture the user at a distance farther or closer than that shown in FIG. 10.

As described above, the capturing angle of a sensor of the imaging device may be adjusted as shown in FIG. 9 to capture the user according to information relating to capturing conditions generated by the exercise device, and the capturing position may be moved as shown in FIG. 10.

In one embodiment, although not shown in the drawing, the electronic device may generate second physical condition information of the user. The second physical condition information may include information relating to the user's physical condition identified via the electronic device. For example, the second physical condition information may include body composition information such as the user's height, weight, skeletal muscle mass, and body fat mass, and information relating to basic physical fitness.

In one embodiment, the electronic device may generate data relating to the user's basic physical fitness and muscle strength based on data obtained by the user performing a predetermined exercise program via the electronic device. Recommended exercise information may be generated based on data relating to the user's basic physical fitness and muscle strength. For example, the electronic device may measure the force with which the user pulls a cable (e.g., cable 406) to generate data relating to the user's muscle strength. For this purpose, a sensor included in a grip portion and cable of the electronic device may be used, and the pulling force may be measured differently according to the resistance value of the cable. For example, the electronic device may measure the time during which the user pulls the cable to generate data relating to the user's muscular endurance. For example, the electronic device may generate data relating to the user's cardiorespiratory endurance based on the number of times the user pulls the cable. In one embodiment, the electronic device may generate data relating to the user's explosive power based on the speed at which the user pulls the cable. For example, the electronic device may generate data relating to the user's balance based on the degree to which the user pulls the cable parallel on both sides. For example, the electronic device may measure the degree to which the user performs the cable use in accordance with usage instructions to generate data relating to the user's coordination. For example, the electronic device may measure the degree to which the user may spread the cable on both sides to generate data relating to the user's flexibility. Based on the foregoing data, the electronic device may generate information relating to the individual's exercise performance ability, and based on the information relating to exercise performance ability and measured body composition data (e.g., weight, height, skeletal muscle mass, body fat mass, etc.), analyze the user's physical fitness and balance (e.g., comparison with average values of the same gender and age group), and based thereon, determine recommended exercise and the intensity of the recommended exercise.

According to one embodiment, in operation 750, the electronic device may receive captured data from the imaging device. The electronic device may receive captured data from the imaging device using short-range wireless communication technology (e.g., BLE, Wi-Fi, NFC).

In one embodiment, the imaging device and display device may transmit captured data to the electronic device. The electronic device may change exercise settings based on captured data received from the imaging device or display device 300. In one embodiment, the electronic device may change the recommended exercise based on the user's physical condition information identified while the user is performing an exercise. In such a case, information relating to the changed recommended exercise information and capturing conditions may be transmitted to the imaging device. In other words, the imaging device and the electronic device may monitor the user's exercise state in real time (e.g., the electronic device monitors the user's physical condition, and the imaging device monitors the user's exercise posture), mutually exchange information relating thereto, and provide feedback in real time according to the user's physical condition and exercise posture.

In one embodiment, the electronic device may generate guide screen information based on captured data. Information relating to the guide screen may include guide exercise demonstration video data, current exercise video of the user, and the user's physical condition information (e.g., heart rate, body temperature, blood pressure, etc.). In the following description, the electronic device generating information relating to the guide screen is described as an example, but this is merely an example, and information relating to the guide screen may be generated in the imaging device as well as the electronic device.

In one embodiment, the electronic device may directly display information relating to the generated guide screen. For example, the guide screen may be displayed on a screen or on a body portion of the electronic device via a projector included in the electronic device.

In one embodiment, the electronic device may transmit information relating to the generated guide screen to at least one of a user device, the electronic device, and a display device. A device that receives information relating to the guide screen may display the information relating to the guide screen.

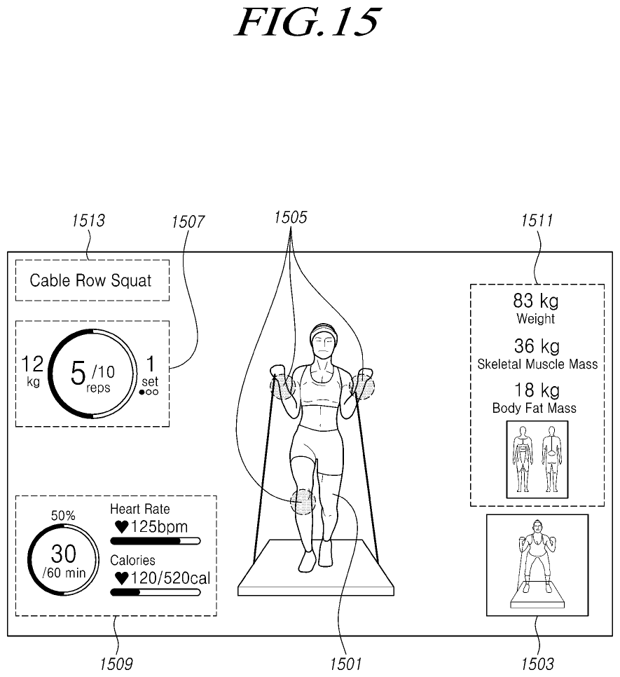

FIG. 15 illustrates an example of a guide screen according to an embodiment of the disclosure.

Referring to FIG. 15, the guide screen may include an object 1501 representing a user performing an exercise. The object 1501 may be displayed based on captured data obtained by the imaging device capturing the user performing an exercise based on information relating to capturing conditions.

In one embodiment, the guide screen may include an object 1503 representing a reference posture of the exercise performed by the user. The reference posture of the exercise may include video pre-stored in the exercise device, imaging device, or server device according to the exercise performed by the user.

In one embodiment, the guide screen may include an object 1505 representing a feedback portion. The object 1505 representing the feedback portion may include a portion where feedback is needed by comparing the reference posture with the user's exercise posture. For example, if the reference posture is a posture of bending the knee, but the user is performing the exercise with the knee extended, an object indicating that feedback is needed at the knee portion (e.g., displayable in the form of a predetermined shape, text, etc.) may be displayed.

In one embodiment, the guide screen may include objects 1507 and 1513 representing the intensity and type of exercise being performed by the user. The object 1513 may include information relating to the type of exercise currently being performed by the user. For example, referring to FIG. 15, the object 1507 may include information relating to the intensity of the exercise currently being performed by the user (e.g., weight (12 kg), current number of repetitions and target number of repetitions (e.g., 5, 10 reps), target number of sets and current set (e.g., target 3 sets, 1 set in progress).

In one embodiment, the guide screen may include an object 1511 including second physical condition information. For example, the information in object 1511 may include body composition information of the user measured from the electronic device (e.g., weight (83 kg), skeletal muscle mass (36 kg), body fat mass (18 kg)).

In one embodiment, the guide screen may include an object 1509 including the user's physical condition information (e.g., first physical condition information) measured via the electronic device or user device. For example, the object 1509 may include information relating to exercise time (e.g., 30 minutes), target time (60 minutes), heart rate (e.g., 125 bpm), consumed calories and target calories (120/520).

The guide screen described in FIG. 15 is merely an example, and the positions of objects and information included in objects may be configured in various ways. For example, according to the user's settings, the object 1501 representing the user's exercise posture may be displayed at the lower right, and the object 1503 may be displayed at the center of the screen.

According to one embodiment, in operation 760, an exercise guide screen may be displayed based on the recommended exercise information and captured data.

In one embodiment, the electronic device may directly display information relating to the guide screen. For example, the electronic device may display the guide screen via a display panel included in the electronic device. For example, the electronic device may project the guide screen via a projector included in the electronic device. The electronic device may identify the direction in which the user is looking and may project the screen in that direction.

In one embodiment, the electronic device may transmit information relating to the guide screen to the display device. In such a case, the display device may display the information relating to the guide screen.

In one embodiment, the electronic device may transmit information relating to the guide screen to the imaging device. The imaging device may display the guide screen based on information relating to the guide screen received from the exercise device. The imaging device may recognize the direction in which the user is looking and may project the guide screen toward the direction the user is looking (e.g., forward, downward, ceiling, etc.).

In one embodiment, the electronic device may transmit information relating to the guide screen to the user device. The user device may display information relating to the guide screen on a display of the user device.

In one embodiment, the electronic device may not only display information relating to the guide screen, but also analyze the user's exercise posture based on captured data received from the imaging device, and output feedback information generated accordingly as sound. For example, the feedback information may be output via an acoustic output device (e.g., speaker) included in the user device, exercise device, imaging device, or display device.

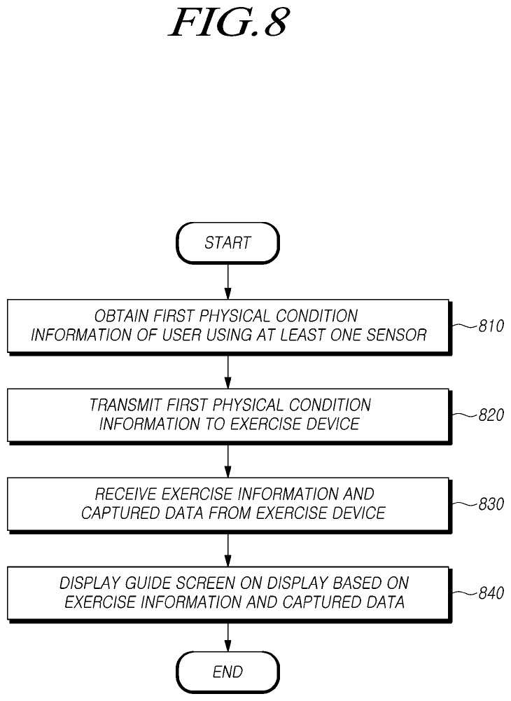

FIG. 8 illustrates an operating flow of a user device according to an embodiment of the disclosure. The user device of FIG. 8 may include a device corresponding to user device 110.

According to one embodiment, in operation 810, the user device may obtain first physical condition information of the user using at least one sensor.

In one embodiment, the first physical condition information may include physical information of the user identified by the user device. For example, the first physical condition information may include information relating to the user's heart rate, body temperature, blood pressure, and activity level.

According to one embodiment, in operation 820, the user device may transmit first physical condition information to the exercise device. Operation 820 may include all of the operational content according to operation 604 of FIG. 6 and operation 720 of FIG. 7.

According to one embodiment, in operation 830, the user device may receive recommended exercise information and captured data from the exercise device. Operation 830 may include all of the operational content according to operation 610 and operation 612 of FIG. 6.

According to one embodiment, in operation 840, the user device may display a guide screen on a display based on the recommended exercise information and captured data. Operation 840 may include all of the operational content according to operation 612 of FIG. 6.

In one embodiment, the user device may transmit first physical condition information to the server device via the communication unit. In one embodiment, the user device may receive recommended exercise information and captured data from the server device via the communication unit.

In an embodiment, the user device may receive feedback information from the exercise device via the communication unit. The user device may output the feedback information as sound.

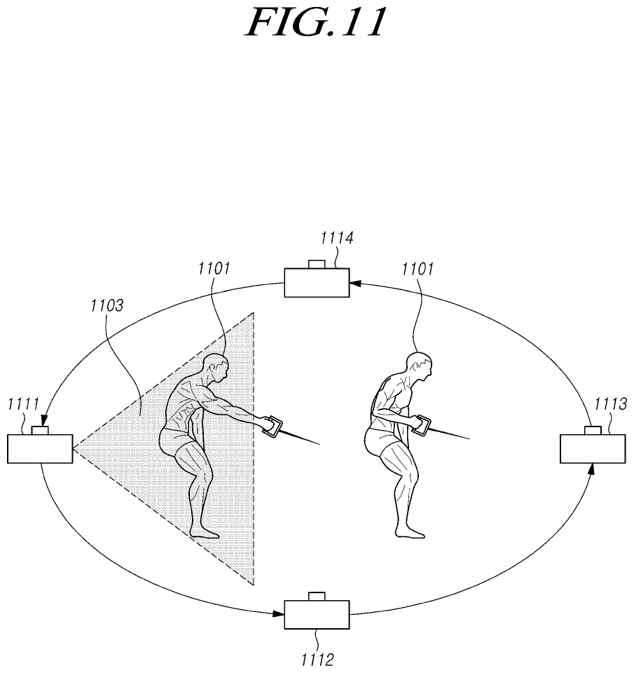

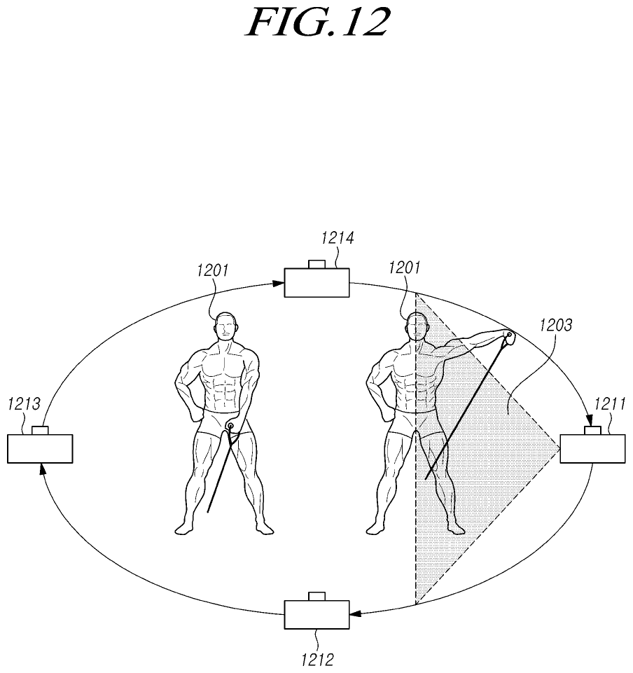

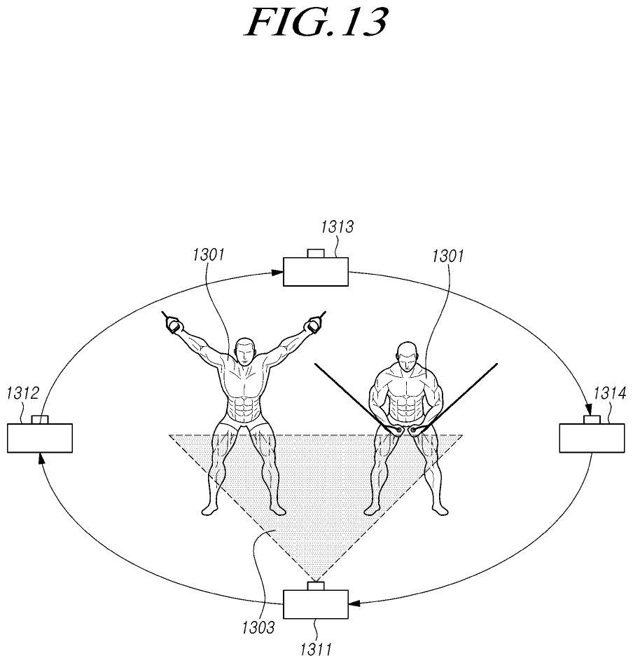

FIG. 11 illustrates an example of acquisition of captured data according to an embodiment of the disclosure. FIG. 12 illustrates an example of acquisition of captured data according to an embodiment of the disclosure. FIG. 13 illustrates an example of acquisition of captured data according to an embodiment of the disclosure. The examples of acquisition of captured data illustrated in FIGS. 11 to 13 relate to examples in which, according to operation 740, the exercise device transmits information about recommended exercise information and capturing conditions to the imaging device, and then the imaging device performs capturing.

Referring to FIG. 11, the exercise device may determine a right back exercise as a recommended exercise for the user. Accordingly, the capturing region is determined as the upper back part of the user's rear (e.g., back), and the capturing position and movement path may be determined as the first position 1111 and a counterclockwise direction. Accordingly, the imaging device may capture 1103 the user's rear at the first position 1111, which is the rear of the user 1101, and may capture the user's exercise posture while moving to the second position 1112, which is the right side, the third position 1113, which is the front, and the fourth position 1114, which is the left side.

Referring to FIG. 12, the exercise device may determine a left shoulder exercise as a recommended exercise for the user. Accordingly, the capturing region is determined as the left side upper body part (e.g., shoulder), and the capturing position and movement path of the imaging device may be determined as the first position 1111 and a clockwise direction. Accordingly, the imaging device may capture 1203 the user's left side at the first position 1211, which is the side of the user 1201. Thereafter, the imaging device may capture the user's exercise posture while moving to the second position 1212, which is the front, the third position 1213, which is the right side, and the fourth position 1214, which is the rear.

Referring to FIG. 13, the exercise device may determine a chest exercise as a recommended exercise for the user. Accordingly, the capturing region is determined as the front upper body part (e.g., chest), and the capturing position and movement path of the imaging device may be determined as the first position 1311 and a clockwise direction (or counterclockwise direction). Accordingly, the imaging device may first capture 1303 the front upper body part of the user at the first position 1311, which is the front of the user 1301. Thereafter, the imaging device may capture the user's exercise posture while moving clockwise to the second position 1312, which is the left side, the third position 1313, which is the rear, and the fourth position 1314, which is the left side.

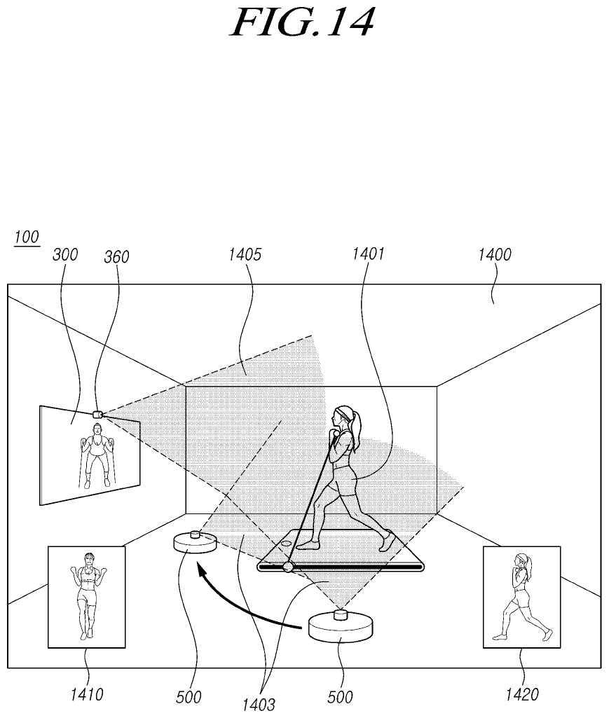

FIG. 14 illustrates an example of an exercise environment 1400 of a user according to an embodiment of the disclosure.

Referring to FIG. 14, in response to identifying that the user 1401 mounts on the exercise device, the exercise device may generate recommended exercise information for the user and may transmit information about the recommended exercise information and capturing conditions to the imaging device. The imaging device 500 may capture 1403 the user at least one position (e.g., left side of the user, front) based on information about capturing conditions. Accordingly, the imaging device 500 may obtain captured data 1420 captured from the left side and captured data 1410 captured from the front. Also, the user may be captured via the sensing unit 360 of the display device 300. In other words, the captured data 1410 captured from the front of the user may be captured by the display device 300 as well as the imaging device.

In an embodiment, the imaging device or the exercise device may generate information about the guide screen based on captured data generated as the user performs the exercise, recommended exercise information, and physical condition information of the user, and may directly display it or transmit it to the display device 300. For example, referring to FIG. 14, the display device 300 may display a screen based on information about the guide screen received from the exercise device 400 or the imaging device 500.

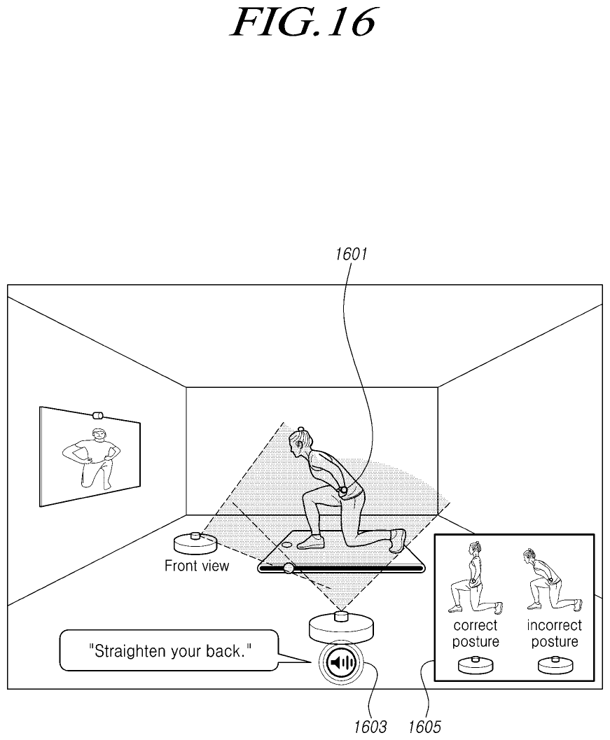

FIG. 16 illustrates an exercise environment of a user according to an embodiment of the disclosure.

Referring to FIG. 16, according to an embodiment, the exercise device, the imaging device, or the display device may not only display guide screen information to the user 1601, but also analyze the user's exercise posture based on captured data received from the imaging device, and output feedback information generated accordingly as sound.

In an embodiment, feedback information may be output via a sound output device (e.g., speaker) included in the user device, the exercise device, the imaging device, or the display device. For example, referring to FIG. 16, feedback information 1603 (e.g., “straighten your back straight”) may be output using the sound output unit of the imaging device. The feedback information 1605 may include information about correct posture and incorrect posture.

In an embodiment, at least one of the exercise device, the display device, the imaging device, and the user device may output feedback information.

In an embodiment, the exercise device may identify the user's voice selecting a device to output feedback information via an input unit (e.g., input unit 450) included in the exercise device. For example, when the exercise device (or the imaging device) identifies a user input selecting to receive feedback information via the display device, voice or a screen may be output via the selected device.

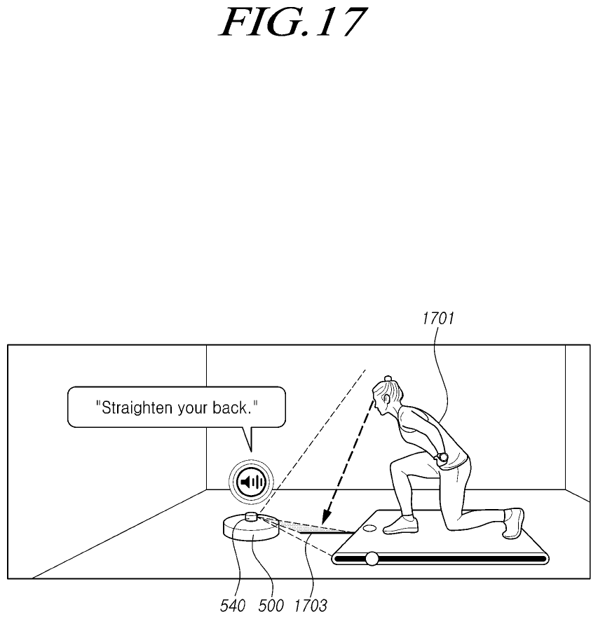

FIG. 17 illustrates an example of displaying a guide screen according to an embodiment of the disclosure.

In an embodiment, the imaging device may display information about the guide screen.

In an embodiment, the imaging device may identify the direction in which the user is looking. For example, referring to FIG. 17, the imaging device 500 may identify that the direction in which the user 1701 is looking is the floor.

In an embodiment, the imaging device may project the guide screen in the direction in which the user is looking. For example, referring to FIG. 17, the imaging device may project the guide screen 1703 toward the floor, which is the direction in which the user 1701 is looking.

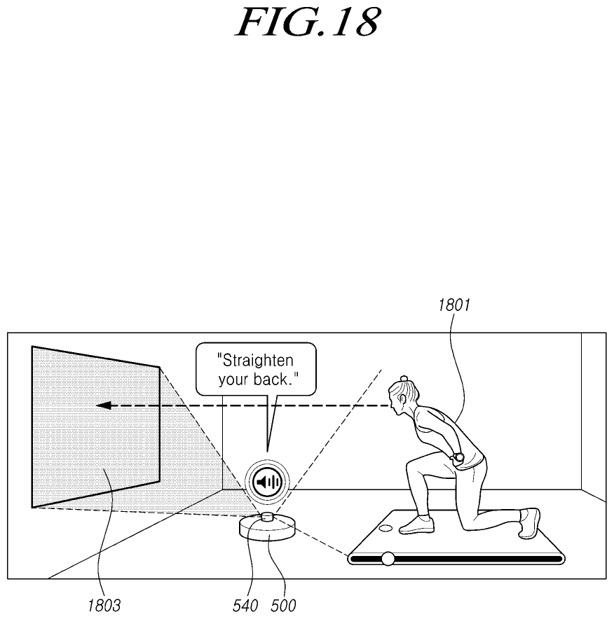

FIG. 18 illustrates an example of displaying a guide screen according to an embodiment of the disclosure.

In an embodiment, the imaging device may display information about the guide screen.

In an embodiment, the imaging device may identify the direction in which the user is looking. For example, referring to FIG. 18, the imaging device 500 may identify that the direction in which the user 1801 is looking is a front direction.

In an embodiment, the imaging device may project the guide screen in the direction in which the user is looking. For example, referring to FIG. 18, the imaging device may project the guide screen 1803 toward the front direction, which is the direction in which the user 1801 is looking.

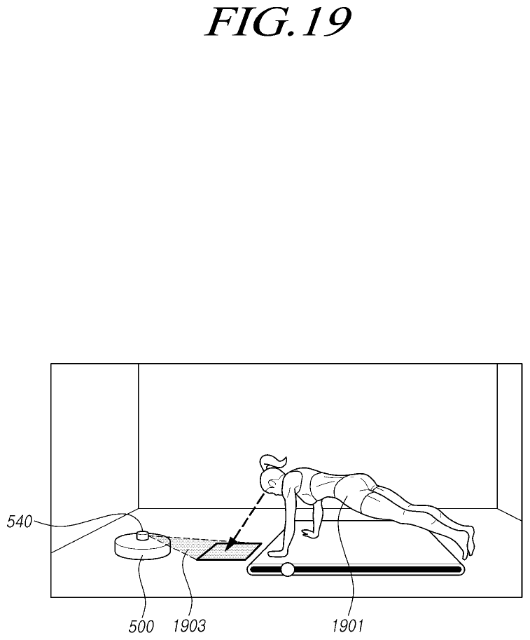

FIG. 19 illustrates an example of displaying a guide screen according to an embodiment of the disclosure.

In an embodiment, the imaging device may display information about the guide screen.

In an embodiment, the imaging device may identify the direction and position in which the user is looking. For example, referring to FIG. 19, the imaging device 500 may identify that the direction in which the user 1901 is looking is a floor direction at a position spaced at a certain distance from the exercise device.

In an embodiment, the imaging device may project the guide screen to the location and direction in which the user is looking. For example, referring to FIG. 19, the imaging device may project the guide screen 1903 toward the floor, which is the direction in which the user 1901 is looking. The imaging device may move the position to accurately project the screen to the location where the user is looking.

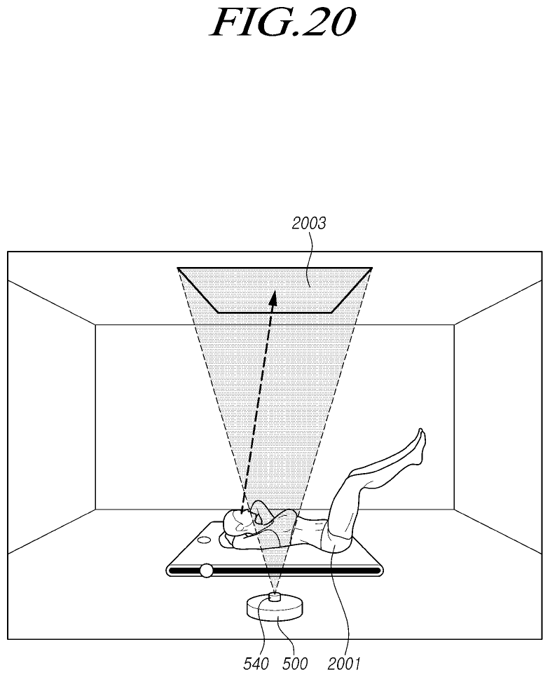

FIG. 20 illustrates an example of displaying a guide screen according to an embodiment of the disclosure.

In an embodiment, the imaging device may display information about the guide screen.

In an embodiment, the imaging device may identify the direction and position in which the user is looking. For example, referring to FIG. 20, the imaging device 500 may identify that the direction in which the user 1901 is looking is a ceiling direction.

In an embodiment, the imaging device may project the guide screen to the location and direction in which the user is looking. For example, referring to FIG. 20, the imaging device may project the guide screen 2003 toward the ceiling, which is the direction in which the user 2001 is looking. The imaging device may move the position to accurately project the screen to the location where the user is looking.

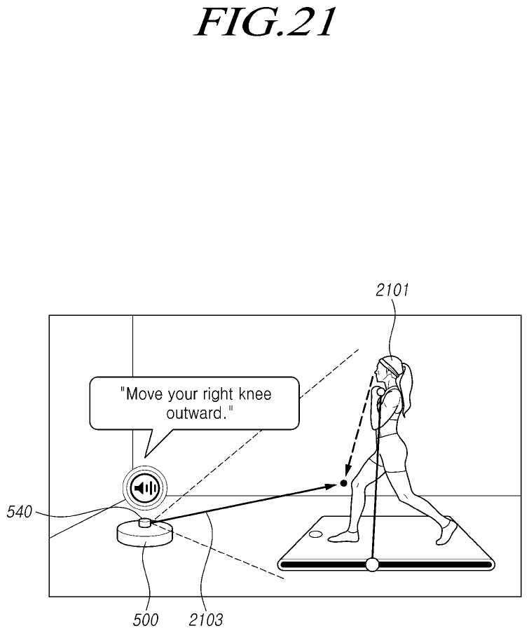

FIG. 21 illustrates an example of displaying feedback information according to an embodiment of the disclosure.

In an embodiment, the imaging device may display feedback information.

In an embodiment, feedback information may be output via a screen or acoustic output, but may also be output by displaying a portion requiring feedback via a projection device such as a laser pointer.

For example, referring to FIG. 21, the imaging device 500 may generate feedback information (e.g., “move your right knee outside”) for a user 2101 performing exercise. Since the portion subject to feedback is the user's right knee portion, the portion may be marked 2103 (e.g., laser pointer).

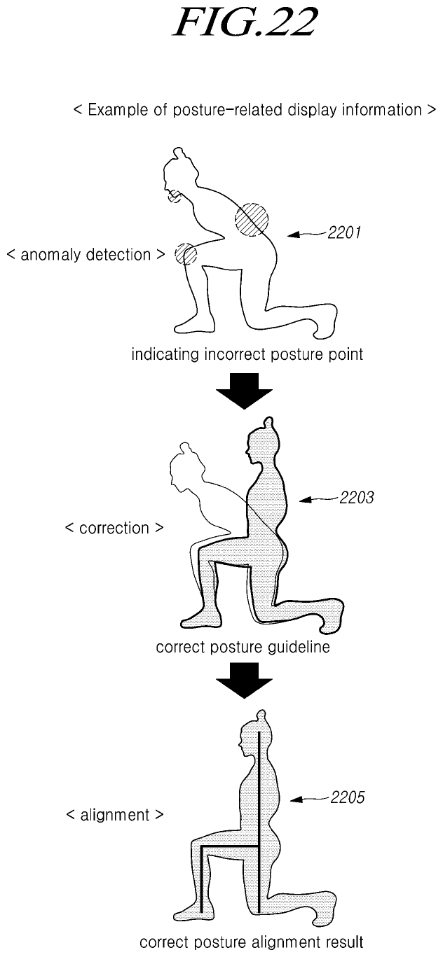

FIG. 22 illustrates an example of feedback information according to an embodiment of the disclosure of the disclosure.

Referring to FIG. 22, the feedback information may include data 2201 relating to an exercise posture of the user. The imaging device or exercise device may identify an incorrect portion in data 2201 relating to the exercise posture of the user, and generate data 2203 by overlapping the user's posture and a reference posture (correct posture). The user may identify a difference between the current posture and the reference posture based on data 2203 and thus correct the posture accordingly. Accordingly, the imaging device or exercise device may obtain data 2205 representing the corrected posture.

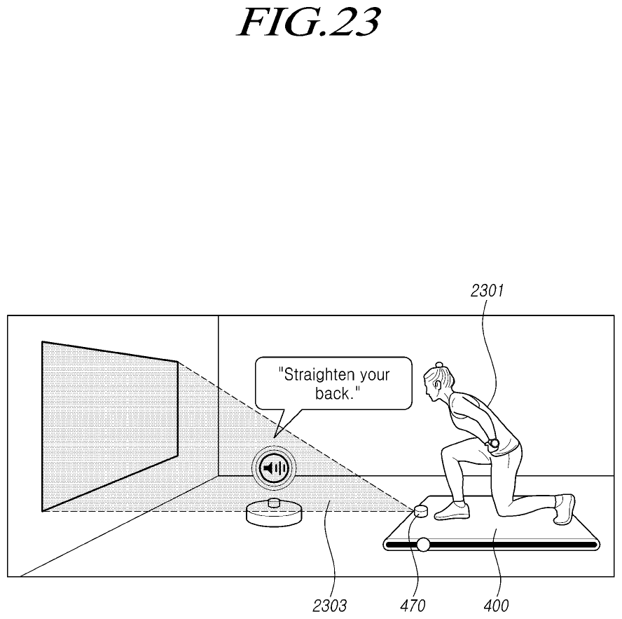

FIG. 23 illustrates an example of guide screen display according to an embodiment of the disclosure of the disclosure.

In an embodiment, the exercise device may display information relating to a guide screen.

In an embodiment, the exercise device may identify a direction and position in which the user is looking. For example, referring to FIG. 23, the exercise device 400 may identify that the direction in which the user 2301 is looking is a front direction.

In an embodiment, the exercise device may project a guide screen toward a position and direction in which the user is looking via the display 470 (e.g., projector). For example, referring to FIG. 23, the imaging device may project the guide screen 2303 toward the front, which is the direction in which the user 2301 is looking.

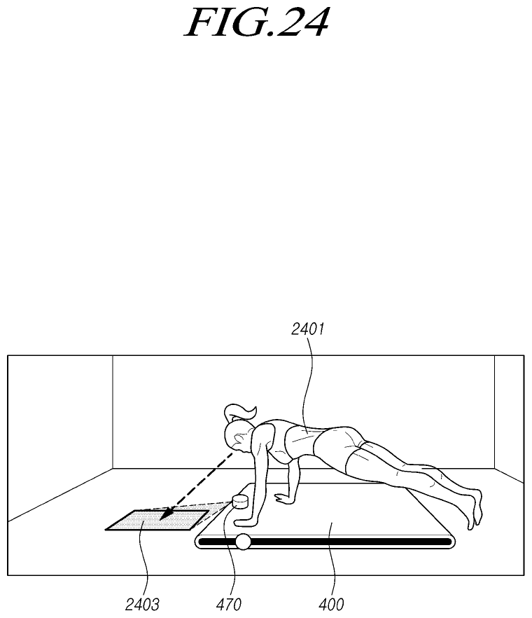

FIG. 24 illustrates an example of guide screen display according to an embodiment of the disclosure of the disclosure.

In an embodiment, the exercise device may display information relating to a guide screen.

In an embodiment, the exercise device may identify the direction and position in which the user is looking. For example, referring to FIG. 24, the exercise device 400 may identify that the direction in which the user 2401 is looking is a floor direction.

In an embodiment, the exercise device may project a guide screen toward a position and direction in which the user is looking via the display 470 (e.g., projector). For example, referring to FIG. 24, the imaging device may project the guide screen 2403 toward the floor, which is the direction in which the user 2401 is looking.

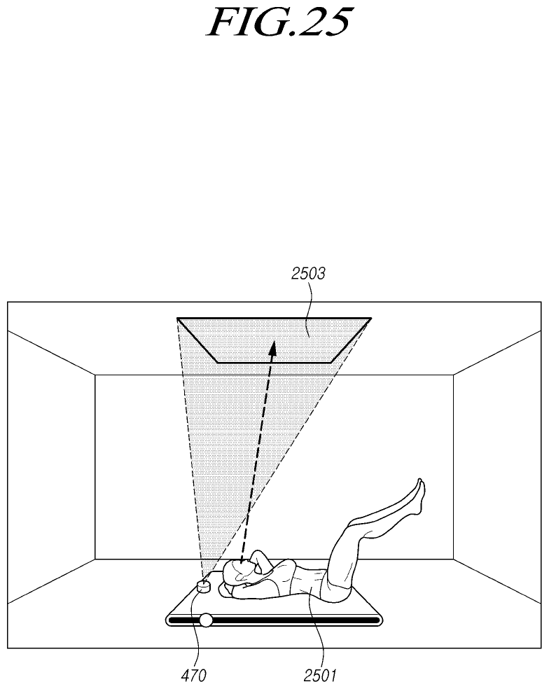

FIG. 25 illustrates an example of guide screen display according to an embodiment of the disclosure.

In an embodiment, the exercise device may display information relating to a guide screen.

In an embodiment, the exercise device may identify the direction and position in which the user is looking. For example, referring to FIG. 25, the exercise device 400 may identify that the direction in which the user 2501 is looking is a ceiling direction.

In an embodiment, the exercise device may project a guide screen toward a position and direction in which the user is looking via the display 470 (e.g., projector). For example, referring to FIG. 25, the imaging device may project the guide screen 2503 toward the ceiling, which is the direction in which the user 2501 is looking.

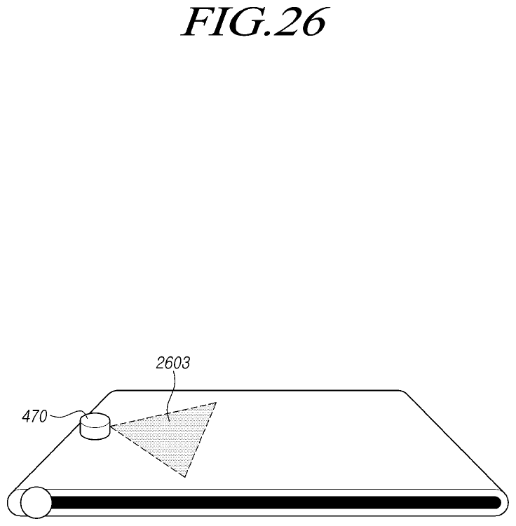

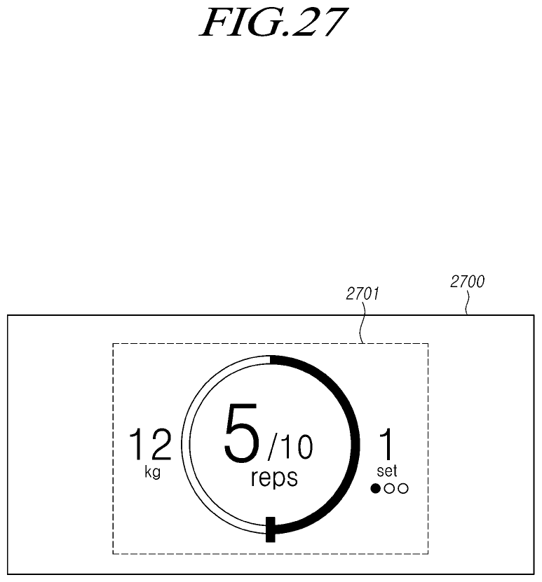

FIG. 26 illustrates an example of guide screen display according to an embodiment of the disclosure. FIG. 27 illustrates an example of a guide screen according to an embodiment of the disclosure.

In an embodiment, the exercise device may display information relating to a guide screen on the body portion of the exercise device. For example, referring to FIG. 26, the exercise device may display the guide screen 2603 on the body portion of the exercise device via the display 470 (e.g., projector) of the exercise device.

According to an embodiment, in addition to a guide screen containing information such as that shown in FIG. 15, there may be a guide screen that displays only partial information considering the size of the displayed area. For example, referring to FIG. 27, the guide screen 2700 may include information 2701 relating to exercise intensity (e.g., exercise intensity, repetition number, set number).

An electronic device for exercise of a user according to an embodiment of the disclosure may include at least one sensor, a communication unit, and a processor electrically connected to the at least one sensor and the communication unit. In an embodiment, the processor may identify a user device located adjacent to the electronic device via at least one of the at least one sensor and the communication unit. In an embodiment, the processor may receive first physical condition information of the user from the user device via the communication unit. In an embodiment, the processor may generate recommended exercise information and information relating to user capturing conditions based on the first physical condition information of the user. In an embodiment, the processor may transmit the recommended exercise information and the information relating to the capturing conditions to the imaging device. In an embodiment, the processor may receive captured data from the imaging device. In an embodiment, the processor may display an exercise guide screen based on exercise information and the captured data.

In an embodiment, the processor may receive information relating to exercise history from the user device via the communication unit. In an embodiment, the processor may generate the recommended exercise information based on the information relating to the exercise history and the first physical condition information.

In an embodiment, the electronic device may include at least one sensor including a camera. In an embodiment, the processor may recognize at least a part of the body of the user via the camera. In an embodiment, the processor may identify the user based on at least a part of the body of the user.

In an embodiment, the processor may identify a direction in which the user is looking based on the captured data.

In an embodiment, the electronic device may include an image projection unit electrically connected to the processor. In an embodiment, the processor may project an image including information relating to an exercise state of the user toward the direction via the image projection unit.

In an embodiment, the electronic device may include a motor connected to the processor. In an embodiment, the processor may identify an exercise state of the user based on an electrical signal identified by the motor. In an embodiment, the processor may generate the exercise information based on the exercise state.

In an embodiment, the processor may update the exercise information based on at least one of the first physical condition information, second physical condition information obtained via the at least one sensor, or the captured data.

In an embodiment, the information relating to the capturing conditions may include information relating to at least one position at which the imaging device captures the user, information relating to a capturing region, and information relating to a movement path.

User device according to an embodiment of the disclosure may include at least one sensor, a communication unit, a display, a processor electrically connected to the at least one sensor, the communication unit and/or the display. In an embodiment, the processor may obtain first physical condition information of the user using the at least one sensor. In an embodiment, the processor may transmit the first physical condition information to the exercise device. In an embodiment, the processor may receive exercise information and captured data from the exercise device. In an embodiment, the processor may display the guide screen on the display based on the exercise information and the captured data.

In an embodiment, the processor may obtain second physical condition information using the at least one sensor. In an embodiment, the processor may transmit the second physical condition information to the exercise device.

In an embodiment, the processor may transmit identification information of the user to the exercise device via the communication unit.

In one embodiment, the processor may transmit the first physical condition information to a server device via the communication unit. In one embodiment, the processor may receive the exercise information and the captured data from the server device via the communication unit. In one embodiment, the server device may include an Internet of Things (IoT) server device that manages the user device and the exercise device.

A method of operating an electronic device for user exercise according to an embodiment of the disclosure may include an operation of identifying a user device located adjacent to the electronic device. In one embodiment, the method of operating the electronic device may include an operation of receiving the first physical condition information of the user from the user device via the communication unit. In one embodiment, the method of operating the electronic device may include an operation of generating recommended exercise information and information on capturing conditions based on the first physical condition information of the user. In one embodiment, the method of operating the electronic device may include an operation of transmitting the recommended exercise information and information on the capturing conditions to an imaging device. In one embodiment, the method of operating the electronic device may include an operation of receiving captured data from the imaging device. In one embodiment, the method of operating the electronic device may include an operation of displaying an exercise guide screen based on the exercise information and the captured data.

In one embodiment, the method of operating the electronic device may include an operation of receiving information on exercise history from the user device. In one embodiment, the method of operating the user device may include an operation of generating the recommended exercise information based on the information on the exercise history and the first physical condition information.

In one embodiment, the method of operating the electronic device may include an operation of recognizing at least a portion of the body of the user via a camera. In one embodiment, the method of operating the user device may include an operation of identifying the user based on at least a portion of the body of the user.

In one embodiment, the method of operating the electronic device may include an operation of identifying a direction in which the user is looking based on the captured data.

In one embodiment, the method of operating the electronic device may include an operation of projecting an image including information on an exercise state of the user toward the direction via an image projection unit.

In one embodiment, the method of operating the electronic device may include an operation of identifying the exercise state of the user based on an electrical signal identified by a motor. In one embodiment, the method of operating the user device may include an operation of generating the exercise information based on the exercise state.

In one embodiment, the method of operating the electronic device may include an operation of updating the exercise information based on at least one of the first physical condition information and second physical condition information obtained via at least one sensor, or the captured data.

In one embodiment, the information on the capturing condition may include information on at least one position where the imaging device may capture the user, information on a capturing region, and information on a movement path.

The electronic device according to the various embodiments disclosed in this document may be of various forms. The electronic device may include, for example, a display device, a portable communication device (e.g., a smartphone), a computer device, a portable multimedia device, a portable medical device, a camera, a wearable device, or a consumer electronics device. The electronic device according to the embodiments of this document is not limited to the devices described above.

The various embodiments of this document and the terms used therein are not intended to limit the technical features described in this document to specific embodiments, and should be understood to include various modifications, equivalents, or substitutions of said embodiments. For example, a component expressed in the singular should be understood as a concept including a plural component unless the context clearly implies only the singular. It should be understood that the term “and/or” as used in this document encompasses any possible combination of one or more of the listed items. Terms such as “including,” “having,” and “consisting of” used in this disclosure are intended merely to indicate the existence of the features, components, parts, or combinations thereof described in this disclosure, and the use of such terms is not intended to exclude the existence or addition of one or more other features, components, parts, or combinations thereof. In this document, each of the phrases such as “A or B,” “at least one of A and B,” “at least one of A or B,” “A, B or C,” “at least one of A, B and C,” and “at least one of A, B, or C” may include any one of the items listed together in the corresponding phrase, or all possible combinations thereof. Terms such as “first,” “second,” or “first” or “second” may be used simply to distinguish a component from another component and do not limit the components in any other aspect (e.g., importance or order).

The terms “part” or “module” as used in the various embodiments of this document may include a unit implemented in hardware, software, or firmware, and may be used interchangeably with terms such as logic, logic block, component, or circuit, for example. The “part” or “module” may be a component formed integrally, or a minimum unit of said component or a part thereof that performs one or more functions. For example, according to one embodiment, the “part” or “module” may be implemented in the form of an application-specific integrated circuit (ASIC).

In various embodiments of this document, the term “when” may be interpreted to mean “at the time of”, or “at the time of” or “in response to determining” or “in response to detecting” depending on the context. Similarly, “when it is determined” or “when it is detected” may be interpreted to mean “at the time of determining” or “in response to determining”, or “at the time of detecting” or “in response to detecting” depending on the context.

A program executed by the server 208 described through this document may be implemented as a hardware component, a software component, and/or a combination of hardware and software components. The program may be executed by any system capable of executing computer-readable instructions.

Software may include a computer program, code, instruction, or a combination of one or more thereof, and may configure a processing device to operate as desired or command the processing device independently or collectively. Software may be implemented as a computer program including instructions stored in a computer-readable storage media. Examples of a computer-readable storage medium include, for example, magnetic storage media (e.g., read-only memory (ROM), random-access memory (RAM), a floppy disk, a hard disk, etc.) and optical reading media (e.g., a CD-ROM, a digital versatile disc (DVD)). A computer-readable storage medium may be distributed among computer systems connected through a network, and computer-readable code may be stored and executed in a distributed manner. A computer program may be distributed online (e.g., downloaded or uploaded) through an application store (e.g., Play Store™) or directly between two user devices (e.g., smartphones). In the case of online distribution, at least a part of the computer program product may be temporarily stored in or temporarily generated in a device-readable storage medium such as memory of a manufacturer's server, a server of an application store, or a relay server.

According to various embodiments, each component (e.g., a module or a program) of the aforementioned components may include a single or multiple entities, and some of the multiple entities may be separately arranged in different components.

According to various embodiments, one or more of the aforementioned components or operations may be omitted, or one or more other components or operations may be added. Alternatively or additionally, multiple components (e.g., a module or a program) may be integrated into one component. In such a case, the integrated component may perform one or more functions of each component of the multiple components in the same or similar manner as performed by the corresponding component among the multiple components before the integration.

According to various embodiments, operations performed by a module, program, or other component may be executed sequentially, in parallel, repeatedly, or heuristically, or one or more of the operations may be executed in a different order, omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device for exercise of a user, comprising:
at least one sensor;
a communication unit;
memory, comprising one or more storage media, storing instructions; and
at least one processor electrically connected to the memory, the at least one sensor and the communication unit,
wherein the instructions, when executed by the at least one processor individually or collectively, cause the at least one processor to:
identify a user device located adjacent to the electronic device via at least one of the at least one sensor or the communication unit,
receive first physical condition information of the user from the user device via the communication unit,
generate recommended exercise information and information regarding a user capturing condition based on the first physical condition information of the user,
transmit the recommended exercise information and the information regarding the capturing condition to an imaging device,
receive captured data from the imaging device, and
display an exercise guide screen based on the exercise information and the captured data.

2. The electronic device of claim 1, wherein the instructions, when executed by the at least one processor individually or collectively, further cause the at least one processor to:
receive information regarding an exercise history from the user device via the communication unit; and
generate the recommended exercise information based on the information regarding the exercise history and the first physical condition information.

3. The electronic device of claim 1,
wherein the at least one sensor comprises camera, and
wherein the instructions, when executed by the at least one processor individually or collectively, further cause the at least one processor to:
recognize at least a part of a body of the user via the camera, and
identify the user based on the at least a part of the body of the user.

4. The electronic device of claim 1, wherein the instructions, when executed by the at least one processor individually or collectively, further cause the at least one processor to:
identify a direction in which the user is looking based on the captured data.

5. The electronic device of claim 4, comprising:
image projection unit electrically connected to the at least one processor,
wherein the instructions, when executed by the at least one processor individually or collectively, further cause the at least one processor to:
project an image including information regarding an exercise state of the user toward the direction via the image projection unit.

6. The electronic device of claim 1, comprising:
a motor connected to the at least one processor,
wherein the instructions, when executed by the at least one processor individually or collectively, further cause the at least one processor to:
identify an exercise state of the user based on an electrical signal identified by the motor, and
generate the exercise information based on the exercise state.

7. The electronic device of claim 1, wherein the instructions, when executed by the at least one processor individually or collectively, further cause the at least one processor to:
update the exercise information based on at least one of the first physical condition information, second physical condition information obtained via the at least one sensor, or the captured data.

8. The electronic device of claim 1, wherein the information regarding the capturing condition comprises information regarding at least one position at which the imaging device captures the user, information regarding a capturing region, and/or information regarding a movement path.

9. A user device, comprising:
at least one sensor;
a communication unit;
a display;
memory, comprising one or more storage media, storing instructions; and
at least one processor electrically connected to the at least one sensor, the communication unit, the memory, and the display,
wherein the instructions, when executed by the at least one processor individually or collectively, cause the at least one processor to:
obtain first physical condition information of a user using the at least one sensor,
transmit the first physical condition information to an exercise device,
receive exercise information and captured data from the exercise device, and
display a guide screen on the display based on the exercise information and the captured data.

10. The user device of claim 9, wherein the instructions, when executed by the at least one processor individually or collectively, further cause the at least one processor to:
obtain second physical condition information using the at least one sensor; and
transmit the second physical condition information to the exercise device.

11. The user device of claim 9, wherein the instructions, when executed by the at least one processor individually or collectively, further cause the at least one processor to:
transmit identification information of the user to the exercise device via the communication unit.

12. The user device of claim 9,
wherein the instructions, when executed by the at least one processor individually or collectively, further cause the at least one processor to:
transmit the first physical condition information to a server device via the communication unit, and
receive the exercise information and the captured data from the server device via the communication unit, and
wherein the server device includes an Internet of Things (IoT) server device managing the user device and the exercise device.

13. A method performed by an electronic device for exercise of a user, the method comprising:
identifying a user device located adjacent to the electronic device;
receiving first physical condition information of the user from the user device via a communication unit;
generating recommended exercise information and information about a user capturing condition based on the first physical condition information of the user;
transmitting the recommended exercise information and the information about the capturing condition to an imaging device;
receiving captured data from the imaging device; and
displaying an exercise guide screen based on the exercise information and the captured data.

14. The method of claim 13, further comprising:
receiving information regarding an exercise history from the user device; and
generating the recommended exercise information based on the information regarding the exercise history and the first physical condition information.

15. The method of claim 13, further comprising:
recognizing at least a part of a body of the user via a camera; and
identifying the user based on the at least a part of the body of the user.

16. The method of claim 13, further comprising:
identifying a direction in which the user is looking based on the captured data.

17. The method of claim 16, further comprising:
projecting, using an image projection unit electrically connected to the electronic device, an image including information regarding an exercise state of the user toward the direction.

18. The method of claim 13, further comprising:
identifying an exercise state of the user based on an electrical signal identified by a motor connected to the electronic device; and
generating the exercise information based on the exercise state.

19. The method of claim 13, further comprising:
updating the exercise information based on at least one of the first physical condition information, second physical condition information obtained via at least one sensor, or the captured data.

20. The method of claim 13, wherein the information regarding the capturing condition comprises information regarding at least one position at which the imaging device captures the user, information regarding a capturing region, and/or information regarding a movement path.
